(19) United States
(12) Patent Application Publication
(10) Pub. No.: US 2004/0001081 A1
(43) Pub. Date: Jan. 1, 2004

(54) Methods and systems for enhancing electronic program guides

(76) Inventor: David J. Marsh, Sammamish, WA (US)

Correspondence Address: LEE & HAYES PLLC, 421 W RIVERSIDE AVENUE SUITE 500, SPOKANE, WA, 99201

(21) Appl. No.: 10/177,885

(22) Filed: Jun. 19, 2002

(51) Int. Cl. G09G 5/00

(52) U.S. Cl. 345/721; 345/805

(57) ABSTRACT

Various systems and methods enhance a user's electronic program guide (EPG) experience and can permit an EPG system to learn about individual user preferences, and then tailor an EPG rendering or program-recommendation process to those specific user's preferences. Various embodiments can provide EPGs that provide quick visual cues for the user to quickly ascertain the subject matter of programs that might be of particular interest. Various scoring approaches can not only ascertain, on a user-by-user basis, those programs that are most likely to be of interest to a user, but can reduce the amount of information to which such users are exposed in an EPG. Various tools are provided by which the user can rate programs or have programs rated for them.

### RELATED APPLICATIONS

This application is related to the following U.S. Patent Applications, the disclosures of which are incorporated by reference herein:

application Ser. No. 10/125,260, filed Apr. 16, 2002, entitled “Media Content Descriptions” and naming Dave Marsh as inventor;

application Ser. No. 10/125,259, filed Apr. 16, 2002, entitled “Describing Media Content in Terms of Degrees” and naming Dave Marsh as inventor;

application Ser. No. ______, bearing Attorney Docket No. ms1-1088, filed May 11, 2002, entitled “Scoring And Recommending Media Content Based On User Preferences”, and naming Dave Marsh as inventor;

application Ser. No. ______, bearing Attorney Docket No. ms1-1175, filed May 31, 2002, entitled “Entering Programming Preferences While Browsing An Electronic Programming Guide”, and naming Dave Marsh as inventor; and

application Ser. No. ______, bearing Attorney Docket No. ms1-1186, filed Jun. 6, 2002, entitled “Methods and Systems for Generating Electronic Program Guides”, and naming Dave Marsh as inventor.

### TECHNICAL FIELD

This invention relates to media entertainment systems and, in particular, to systems and methods that are directed to personalizing a user's experience.

### BACKGROUND

Many media entertainment systems provide electronic programming guides (EPGS) that allow users to interactively select programs that they are interested in. Systems that employ EPG technology typically display programs organized according to the channel on which the program will be broadcast and the time at which the broadcast will occur. Information identifying a particular program typically includes the program title, and possibly a short description of the program. In today's world, media entertainment systems can typically offer hundreds of channels from which a user can choose. In the future, many more channels will undoubtedly be offered. This alone can present a daunting task for the user who wishes to locate particular programs of interest. Further complicating the user's experience is the fact that many current electronic programming guides (EPGs) can provide an abundance of information that can take several hours for a user to look through. Against this backdrop, what many viewers typically end up doing is that they simply review a few favorite channels to see when their favorite programs are playing, and then view those programs at the appropriate times. Additionally, other viewers may simply revert to channel surfing. Needless to say, these outcomes do not provide the user with the best user experience or make effective and efficient use of the user's time.

Accordingly, this invention arose out of concerns associated with providing improved systems and methods that can provide media entertainment users with a rich, user-specific experience.

### SUMMARY

Various systems and methods can enhance a user's electronic program guide (EPG) experience. Various embodiments can permit an EPG system to learn about individual user preferences, and then tailor an EPG rendering or program-recommendation process to those specific user's preferences.

Various embodiments can provide EPGs that provide quick visual cues for the user to quickly ascertain the subject matter of programs that might be of particular interest. Various scoring approaches can not only ascertain, on a user-by-user basis, those programs that are most likely to be of interest to a user, but can reduce the amount of information to which such users are exposed in an EPG.

Various tools are provided by which the user can rate programs or have programs rated for them. Other tools can enable a user to very specifically tailor criteria that is utilized to evaluate program content for the purpose of making user recommendations. Additionally, various embodiments can enable a user's favorite channels to be determined and then displayed for them to make program selections.

### BRIEF DESCRIPTION OF THE DRAWINGS

FIG. 1 is a block diagram that illustrates program data in accordance with one or more embodiments.

FIG. 2 is a block diagram that illustrates an exemplary environment in which methods, systems, and data structures in accordance with the described embodiments may be implemented.

FIG. 3 is a block diagram that illustrates exemplary components of a content folder in accordance with one embodiment.

FIG. 4 is a flow diagram describing steps in a method in accordance with one embodiment.

FIG. 5 is a high level block diagram that illustrates aspects of but one system that can be utilized to implement one or more embodiments.

FIG. 6 is a block diagram that illustrates exemplary components of a client device in accordance with one embodiment.

FIG. 7 is a block diagram that illustrates a recommendation engine in accordance with one embodiment.

FIG. 8 is a flow diagram describing steps in a method in accordance with one embodiment.

FIG. 9 is an illustration of an exemplary electronic programming guide that can be rendered in accordance with the techniques described herein.

FIG. 10 is a flow diagram describing steps in a method in accordance with one embodiment.

FIG. 11 is a diagram that illustrates an exemplary user input mechanism in accordance with one embodiment.

FIG. 12 is an illustration of an exemplary electronic programming guide that can be rendered in accordance with the techniques described herein.

FIG. 13 is a flow diagram describing steps in a method in accordance with one embodiment.

FIG. 14 is a diagram that illustrates a filtering process in accordance with one embodiment.

FIG. 15 is an illustration of an exemplary recommendation list that can be rendered in accordance with the techniques described herein.

FIG. 16 is a flow diagram describing steps in a method in accordance with one embodiment.

FIG. 17 is a block diagram that illustrates various components that can comprise a client device.

### DETAILED DESCRIPTION

Overview

Electronic program guides (EPGs) can be a very useful tool for assisting various users in identifying programs that may be of interest to them. Yet, as noted above, such EPGs can include so much information, and can be so large in size as to actually degrade the user's experience rather than enhance it.

The discussion below describes various systems and methods that can enhance the user's EPG experience. Various aspects of the embodiments described below can permit an EPG system to learn about individual user preferences, and then tailor an EPG rendering or program-recommendation process to those specific user's preferences. Various embodiments can provide EPGs that provide quick visual cues for the user to quickly ascertain the subject matter of programs that might be of particular interest. Various scoring approaches can not only ascertain, on a user-by-user basis, those programs that are most likely to be of interest to a user, but can reduce the amount of information to which such users are exposed in an EPG.

Further, various tools can provide the user with an opportunity to rate programs or otherwise define how recommendations are to be made to them. Other tools can enable a user to very specifically tailor the criteria that is utilized to evaluate program content for the purpose of making user recommendations. Further, various embodiments described below can enable a user's favorite channels to be determined and then displayed for them to make selections.

The discussion below begins with a description of an exemplary system and approach that can be utilized to implement the embodiments that are described further on in this document. It is to be appreciated that the embodiments described herein can be implemented in connection with any suitable EPG system. Hence, the claimed subject matter should not be limited to only those systems that are the same as, or similar to those described below.

Content Description Metadata Collection

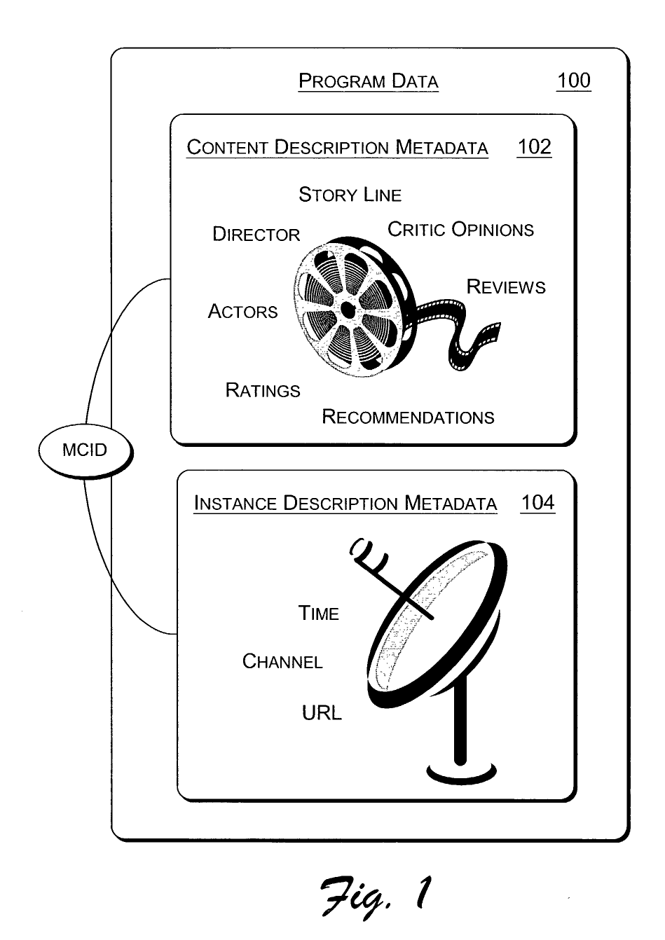

FIG. 1 illustrates two categories of program data 100 that can be associated with various media content (such as movies, television shows and the like) in accordance with the described embodiments. The two types of program data comprise content description metadata 102 and instance description metadata 104.

Content description metadata 102 can comprise a vast number of different types of metadata that pertain to the particular media content. The different types of content description metadata can include, without limitation, the director or producer of the content, actors in a program or movie, story line, ratings, critic opinions, reviews, recommendations, and the like.

Instance description metadata 104 comprises data that pertains to when and where the media content is available. For example, instance description metadata can include the day, time and television channel on which a particular movie or television program will be broadcast. Because content description metadata 102 is associated with the media content itself, and not when a particular instance of the media content is to be broadcast, the content description metadata can be maintained and updated throughout the life of a particular piece of media content.

In accordance with the described embodiments, the content description metadata and the instance description metadata are linked via a media content identifier number 106 or “MCID”. An MCID is a unique number that is assigned to the piece of media content to identify it. The MCID can provide a basis by which the particular media content can be easily and readily identified. Once identified, metadata associated with the media content can be easily updated and extended. MCIDs can also be used to generate electronic programming guides for the users and can provide the basis by which a user's likes and dislikes are measured against media content for purposes of recommending to the user those programs that the user would most like to view.

Exemplary Environment

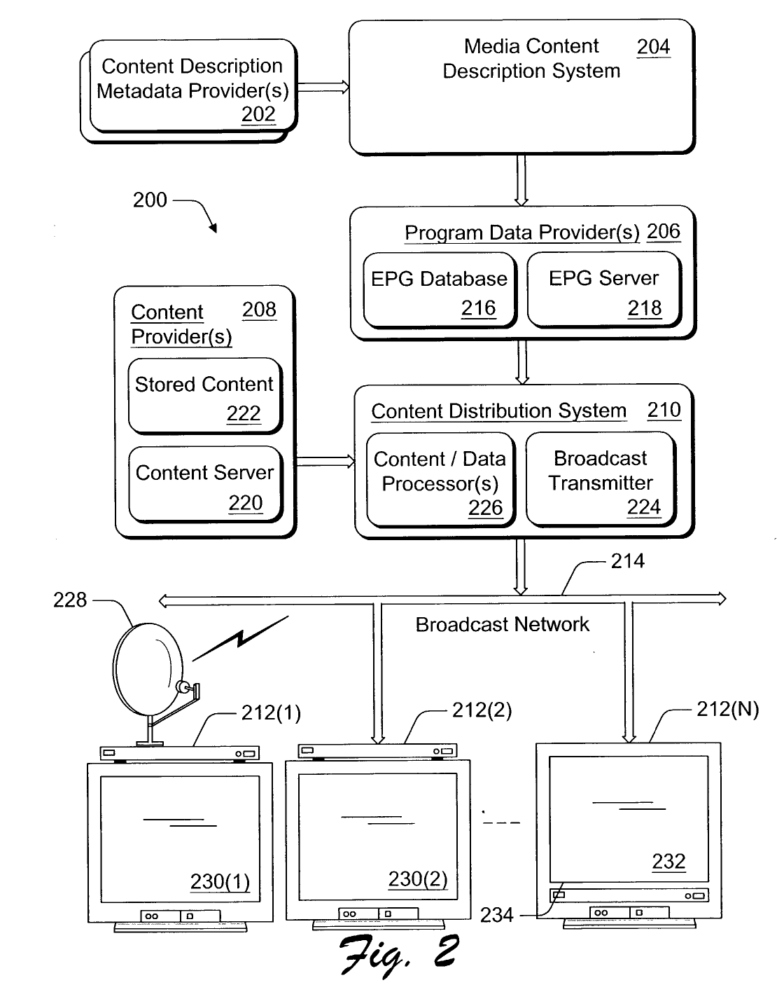

FIG. 2 illustrates an exemplary environment 200 in which the methods, systems, and data structures described herein may be implemented. The environment is a media entertainment system that facilitates distribution of media content and metadata associated with the media content to multiple users. Environment 200 includes one or more content description metadata providers 202, a media content description system 204, one or more program data providers 206, one or more content providers 208, a content distribution system 210, and multiple client devices 212(1), 212(2), . . . , 212(N) coupled to the content distribution system 210 via a broadcast network 214.

Content description metadata provider 202 provides content description metadata associated with media content to media content description system 204. Example content description metadata providers can include, without limitation, movie production companies, movie distribution companies, movie critics, television production companies, program distributors, music production companies, and the like. Essentially, any person, company, system, or entity that is able to generate or supply media content description metadata can be considered a content description metadata provider 202.

Media content description system 204 stores media content description metadata associated with a plurality of metadata categories and stores metadata received from one or more metadata providers 202. In one implementation, the media content description system 204 generates composite metadata based on metadata received from a plurality of metadata providers 202. Media content description system 204 provides the media content description metadata to program data provider 206. Typically, such metadata is associated with many different pieces of media content (e.g., movies or television programs).

Program data provider 206 can include an electronic program guide (EPG) database 216 and an EPG server 218. The EPG database 216 stores electronic files of program data which can be used to generate an electronic program guide (or, “program guide”). The program data stored by the EPG database, also termed “EPG data”, can include content description metadata 102 and instance description metadata 104. For example, the EPG database 216 can store program titles, ratings, characters, descriptions, actor names, station identifiers, channel identifiers, schedule information, and the like.

The EPG server 218 processes the EPG data prior to distribution to generate a published version of the EPG data which contains programming information for all channels for one or more days. The processing may involve any number of techniques to reduce, modify, or enhance the EPG data. Such processes can include selection of content, content compression, format modification, and the like. The EPG server 218 controls distribution of the published version of the EPG data from program data provider 206 to the content distribution system 210 using, for example, a file transfer protocol (FTP) over a TCP/IP network (e.g., Internet, UNIX, etc.). Any suitable protocols or techniques can be used to distribute the EPG data.

Content provider 208 includes a content server 220 and stored content 222, such as movies, television programs, commercials, music, and similar media content. Content server 220 controls distribution of the stored content 222 from content provider 208 to the content distribution system 210. Additionally, content server 220 controls distribution of live media content (e.g., content that is not previously stored, such as live feeds) and/or media content stored at other locations.

Content distribution system 210 contains a broadcast transmitter 224 and one or more content and program data processors 226. Broadcast transmitter 224 broadcasts signals, such as cable television signals, across broadcast network 214. Broadcast network 214 can include a cable television network, RF, microwave, satellite, and/or data network, such as the Internet, and may also include wired or wireless media using any broadcast format or broadcast protocol. Additionally, broadcast network 214 can be any type of network, using any type of network topology and any network communication protocol, and can be represented or otherwise implemented as a combination of two or more networks.

Content and program data processor 226 processes the media content and EPG data received from content provider 208 and program data provider 206 prior to transmitting the media content and EPG data across broadcast network 214. A particular content processor may encode, or otherwise process, the received content into a format that is understood by the multiple client devices 212(1), 212(2), . . . , 212(N) coupled to broadcast network 214. Although FIG. 2 shows a single program data provider 206, a single content provider 208, and a single content distribution system 210, environment 200 can include any number of program data providers and content providers coupled to any number of content distribution systems.

Content distribution system 210 is representative of a head end service that provides EPG data, as well as media content, to multiple subscribers. Each content distribution system 210 may receive a slightly different version of the EPG data that takes into account different programming preferences and lineups. The EPG server 218 creates different versions of EPG data (e.g., different versions of a program guide) that include those channels of relevance to respective head end services. Content distribution system 210 transmits the EPG data to the multiple client devices 212(1), 212(2), . . . , 212(N). In one implementation, for example, distribution system 210 utilizes a carousel file system to repeatedly broadcast the EPG data over an out-of-band channel to the client devices 212.

Client devices 212 can be implemented in multiple ways. For example, client device 212(1) receives broadcast content from a satellite-based transmitter via a satellite dish 228. Client device 212(1) is also referred to as a set-top box or a satellite receiving device. Client device 212(1) is coupled to a television 230(1) for presenting the content received by the client device, such as audio data and video data, as well as a graphical user interface. A particular client device 212 can be coupled to any number of televisions 230 and/or similar devices that can be implemented to display or otherwise render content. Similarly, any number of client devices 212 can be coupled to a television 230.

Client device 212(2) is also coupled to receive broadcast content from broadcast network 214 and communicate the received content to associated television 230(2). Client device 212(N) is an example of a combination television 232 and integrated set-top box 234. In this example, the various components and functionality of the set-top box are incorporated into the television, rather than using two separate devices. The set-top box incorporated into the television may receive broadcast signals via a satellite dish (similar to satellite dish 228) and/or via broadcast network 214. A personal computer may also be a client device 212 capable of receiving and rendering EPG data and/or media content. In alternate implementations, client devices 212 may receive broadcast signals via the Internet or any other broadcast medium.

Each client 212 runs an electronic program guide (EPG) application that utilizes the EPG data. An EPG application enables a TV viewer to navigate through an onscreen program guide and locate television shows of interest to the viewer. With an EPG application, the TV viewer can look at schedules of current and future programming, set reminders for upcoming programs, and/or enter instructions to record one or more television shows.

Content Folders

In accordance with the embodiments described below, the notion of a content folder is employed and utilized to hold metadata that pertains to media content that can be experienced by a user. The content folder can be utilized to hold or otherwise aggregate many different types of metadata that can be associated with the media content-including the media content itself. The metadata that is provided into a content folder can come from many different metadata providers and can be provided at any time during the life of the media content.

As an example, consider the following. When media content is first created, content description metadata can be provided for the particular media content. Such content description metadata can include such things as the name of the content (such as movie or program name), actors appearing in the movie or program, year of creation, director or producer name, story line description, content rating and the like.

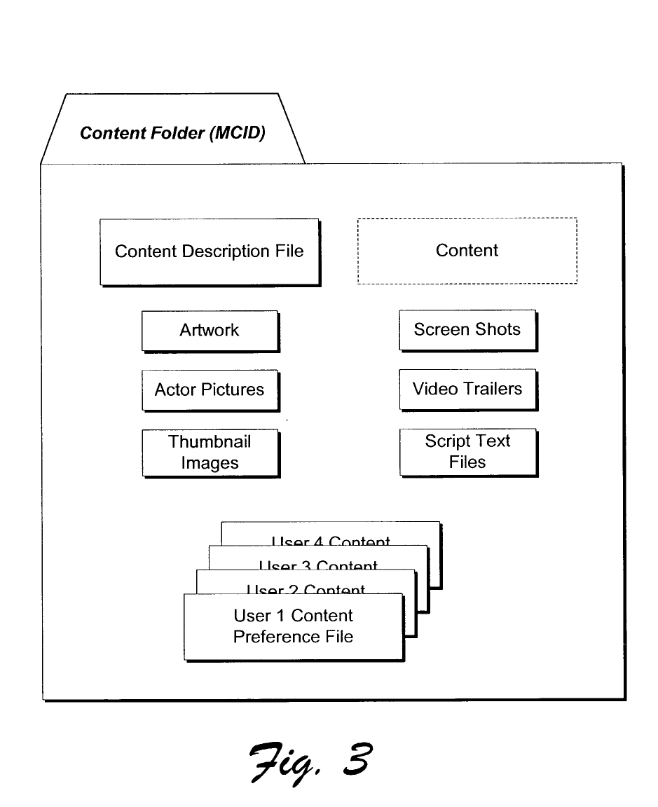

As an example, consider FIG. 3 which shows an exemplary content folder. The content folder is associated with a particular piece of content and, hence, is associated with an MCID that identifies the content. Within the content folder, many different types of metadata can be collected. For example, the content folder can include, without limitation, a content description file that describes the content (an example of which is provided below), and files associated with any artwork that might be associated with the content, actor pictures, thumbnail images, screen shots, video trailers, and script text files, to name just a few. The content folder can also contain the actual content itself, such as a digitally encoded program or movie. The content folder can, in some embodiments, contain one or more user content preference files which are described in more detail in the section entitled “User Content Preference File” below.

Over time, more content description metadata may become available and can be added to the content folder. For example, after a movie is released, critic opinions and recommendations may become available. Because this is information related to the media content itself (and not just a particular broadcast or showing of the media content), this information can be added to the content folder. At a still later point in time, additional reviews of the media content may become available and can thus be added to the content folder. Additional metadata that can be incorporated into the content folder can include such things as special promotional data associated with the content, data from fan sites, and many more different types of metadata.

Content description metadata can typically be generated by many different sources (e.g., movie production companies, movie critics, television production companies, individual viewers, etc.). A media content description system (such as system 204 in FIG. 2) can store content description metadata from the multiple sources, and can make the content description metadata available to users via one or more servers or other content distribution systems.

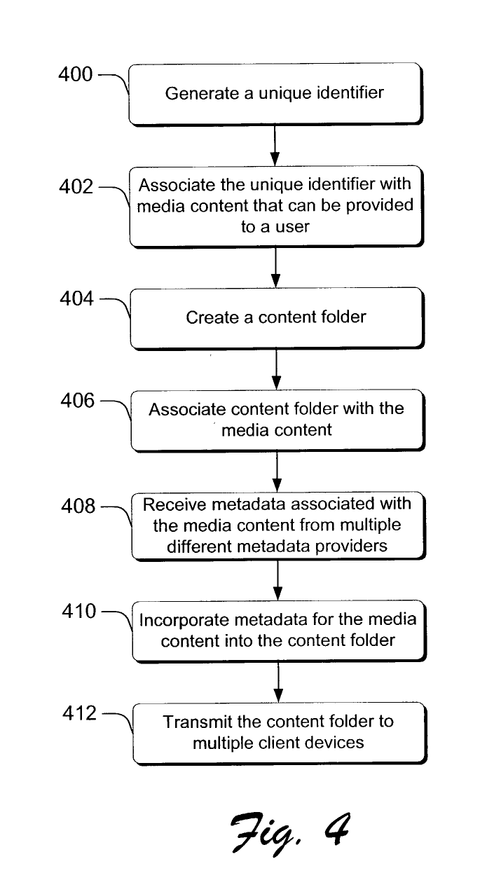

FIG. 4 is a flow diagram that describes steps in a metadata collection method in accordance with one embodiment. The steps can be implemented in any suitable hardware, software, firmware or combination thereof. In the illustrated example, the steps can be implemented in connection with a metadata collection and transmission system. Exemplary components that can perform the functions about to be described are shown and described in connection with FIG. 2.

Step 400 generates a unique identifier and step 402 associates the unique identifier with media content that can be provided to a user. An example of such a unique identifier is described above in connection with the MCID. The media content with which the unique identifier can be associated is a specific piece of media content, such as a specific movie or television program. In practice, these steps are implemented by one or more servers or other entities in connection with a vast amount of media content. The servers or entities serve as a collection point for metadata that is to be associated with the particular media content. Step 404 creates a content folder and step 406 associates the content folder with the particular media content. These steps can also be performed by the server(s) or entities. The intent of these steps is to establish a content folder for each particular piece of media content of interest.

Step 408 receives metadata associated with the media content from multiple different metadata providers. These metadata providers need not and typically are not associated or affiliated with one another. Step 410 then incorporates the metadata that is received from the various metadata providers into the content folder that is associated with the particular media content. As noted above, this process is an ongoing process that can extend during the entire life of the particular piece of media content. The result of this step is that, over time, a very rich and robust collection of metadata is built up for each piece of media content of interest. Software executing on the server can use aggregation techniques to ascertain the best value for each program attribute using the entries from the different metadata providers. For example, different opinions as to the value of attributes can be collected from the different metadata providers. The “best” value, i.e. the one that gets sent to the client, is built by the server software using various techniques depending on the attribute type. For example, sometimes the best value is the value from the most trustworthy metadata provider. Yet other times, a vote can be taken as to the best value. Still further, for example in the case of “Degrees Of” attributes, percentages can be calculated by looking at all of the opinions from the metadata providers. Data aggregation techniques are described in some of the applications incorporated by reference above. An example of a content folder is shown and described in FIG. 3.

Step 412 transmits the content folder to multiple different client devices. This step can be implemented by transmitting all of the constituent files of the content folder, or by transmitting a pared down version of the content folder-depending on the needs and capabilities of the particular client devices to which transmission occurs.

The content folders can be used in different ways. For example, the content folder can be used in an EPG scenario to enable the EPG software on the client device to generate and render an EPG for the user. The content folder can also be used by end users to hold not only the metadata for the media content, but the media content as well.

Using Content Folders to Generate EPGs

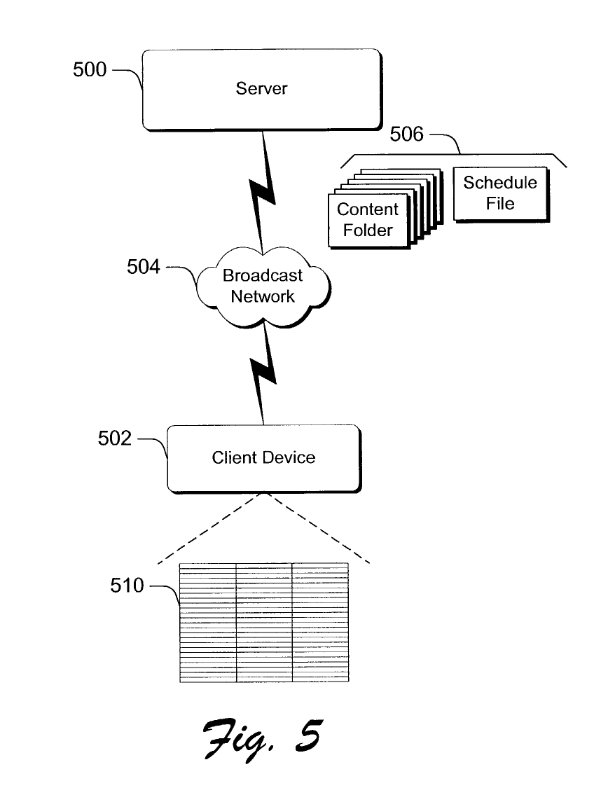

FIG. 5 is a block diagram that can be used to understand how the client device can use the various content folders to generate an EPG. In this example, a server 500 builds and maintains many different content folders, such as the content folders that are described above. In addition, the server can build a schedule file. The content folders and schedule files are shown collectively at 506.

The schedule file is a description of the programs that are to be broadcast over a future time period for which an EPG is going to be constructed. For example, the schedule file can describe which programs are going to be broadcast for the next two weeks. Thus, the schedule file contains the instance description metadata as described in FIG. 1. The schedule file can be implemented as any suitable type of file. In this particular example, the schedule file is implemented as an XML file. The schedule file refers to the pieces of media content (i.e. programs) by way of their respective unique identifiers or MCIDs. Thus, the schedule file contains a list of MCIDs, the times when, and the channels on which the associated programs are going to be broadcast.

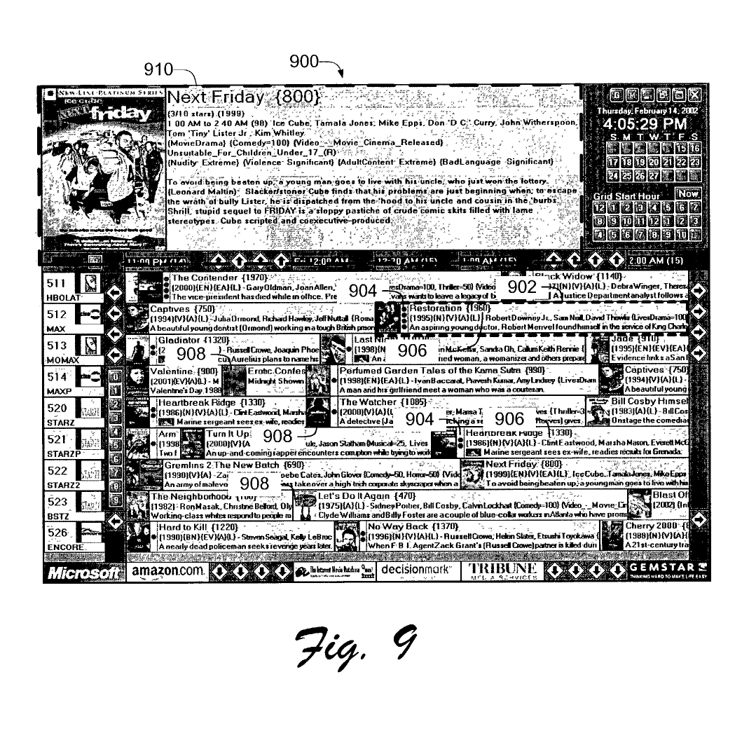

The schedule file and content folders that correspond to the MCIDs in the schedule file are transmitted, via a suitable broadcast network 504, to multiple client devices such as client device 502. The client device can now use the schedule file and the various content folders to construct an EPG grid, such as EPG 510, for the user. A specific example of an EPG such as one that can be generated in accordance with the embodiments described herein is shown in FIG. 9.

Specifically, when the client device receives the schedule file, an EPG application executing on the client device can read the schedule file and ascertain the MCIDs that correspond to the programs that are going to be broadcast. The EPG application can then construct a suitable grid having individual cells that are to contain representations of the programs that are going to be broadcast. Each cell typically corresponds to a different MCID. To populate the grid, the EPG application can access the appropriate the content folders, by virtue of the MCIDs that are associated with the content folders, and render the metadata contained in the content folder in the appropriate cell for the MCID of interest. The EPG application can also provide any user interface (UI) components that are desirable to access additional metadata that is not necessarily displayed-such as a movie trailer, a hyperlink and the like.

In one embodiment, an optimization can be employed to ensure that client devices are provided metadata within the content folder that they can use. Thus, metadata that is not necessarily useful for the client device can be excluded from the content folder that is transmitted to the client device. For example, if the client device does not have a position in its user interface to display a particular piece of information, or if the client device lacks the necessary resources to meaningfully use the metadata (e.g. the client lacks the capabilities to display a video trailer), then such metadata should not be transmitted to the client device when the content folders are transmitted. One way of implementing such an optimization is as follows. Prior to downloading the content folders, server 500 and client device 502 communicate with one another by, for example, a SOAP protocol, and the client device identifies for the server which information or metadata it is interested in. This can assist the server in assigning a class designation to the client device (e.g. thick client, thin client and/or varying degrees therebetween) so that the appropriate metadata is sent to the client.

The content folders can be used by the client device in a couple of different ways depending on the configuration and capabilities of the client device. For clients that are “thick” and support a database querying engine (such as a SQL engine), complex querying can be utilized locally on the client. In this case, certain files (such as the content description file) within the content folder can be read into the client's database and requests for program information can be sent from the EPG application to the database engine for execution. Support files such as the artwork and trailer files are not loaded into the database, but rather are read by the EPG application directly from the content folders. For clients that do not support a database engine, metadata can be read directly from the files.

Using Content Folders to Organize Metadata and Media Content

Content folders can also be used to contain not only the pertinent metadata, but the associated media content as well. This use can occur on either the server or the client side. Typically, however, this use will occur with more frequency on the client side.

Recall from FIG. 5 and the discussion above, that the client devices typically receive multiple different content folders that are individually associated with specific media content that has yet to be broadcast. Thus, as noted in FIG. 3, the client devices will typically have a number of these content folder without the associated content. When the content is acquired by the client, as by being broadcast or downloaded (for example in a Personal Video recorder application), the content itself can be added to the content folder so that individual content folders now contain not only pertinent metadata, but the corresponding content as well. Typically, such content can be digitally encoded into an appropriate file (such as an MPEG 2 file) and added to the content folder.

This can be advantageous from the standpoint of being able to abstract a specific piece of media content into an entity (i.e. the content folder) that represents not only the content itself, but a potentially rich user experience made possible by the inclusion of the various types of metadata with the content. Having an abstracted entity that contains not only the content, but the associated metadata as well can be employed in the context of peer-to-peer exchanges. For example, if a user wishes to provide a piece of content to a friend, then they can simply send them the abstracted entity that includes not only the content, but all of the supporting metadata files as well.

Exemplary Client Architecture

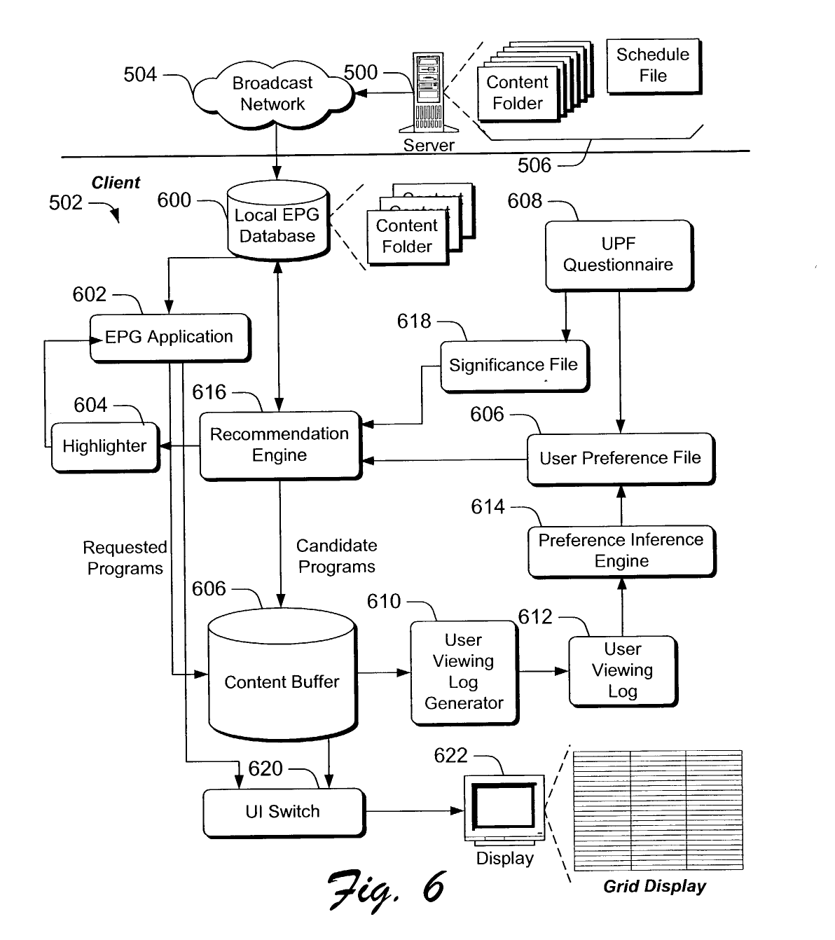

FIG. 6 is a block diagram that illustrates exemplary components of a client system or device 502 in accordance with one embodiment, and expands upon the client device shown and described in FIG. 5. Client system 502 can operate as a user preference recommendation system that can score programs that are available for viewing according to a user's preferences, and recommend certain programs that meet particular conditions that are specific to a particular user.

Client system 502 can include a local electronic programming guide (EPG) database 600 that stores content folders that can include content files, support files and content description files associated with the content files that are downloaded from a server. An exemplary content description file is described in the section entitled “Content Description File” below. Database 600 can also store the schedule file. The database can comprise a traditional database such as that which would reside on a thick client. Alternately, for thin clients, the database would typically be less extensive than for thick clients.

The EPG database 600 provides data to an electronic programming guide (EPG) application 602. The EPG application 602 is configured to enable displays of program names, dates, times, lengths, etc. in a grid-like user interface. A highlighter component 604 can highlight particular programs displayed on an EPG grid. The particular programs that can be highlighted by the highlighter component 604 can be a function of a user's likes and dislikes. Client 502 also includes a content buffer 606 that can store content folders and media content associated with particular content folders. For example, the content buffer can be utilized to store programs that are designated by the user for recording so that the user can later view the program. This will become more apparent in connection with the discussion that appears in the section entitled “Recommendation Lists” below.

The client 502 also includes one or more user preference files (UPF) 606 associated with a user or users of the client. The client 502 can contain more than one user preference file for each user.

The user preference file can be utilized to store values for various attributes of media content (such as television programs). Each attribute value can have a preference value associated with it that indicates how much the particular user likes or dislikes that particular attribute value in a program. Advantageously, the user preference file and the content description file can conform to a common content description schema which can facilitate matching up various programs with the user's preferences. The user preference file 606 can advantageously allow for the separation of the process of establishing user preferences, from the process of matching the user preferences with programs that are available for viewing.

Various techniques can be utilized to populate user preference file 606 with useful information about the user, such as what attribute values of television programs are liked and disliked by the user.

One way to generate a user preference file is to provide the user with a UPF questionnaire 608 that queries the user directly about which attribute values are important to the user. After the user preference file is initially constructed, it can be periodically updated with new information about preferred program attribute values. The user may, for example, simply recall the UPF questionnaire 608 and add additional information or edit information that is already in the file.

Another way to generate a user preference file makes use of a user viewing log generator 610 that monitors programs that are watched by the user or listed by the user for consumption. Program attribute values associated with the monitored programs, together with the time that the program was viewed are logged in a user viewing log 612. At predetermined intervals, a preference inference engine 614 can build up the user preference file using information contained in the user viewing log 612. User preference files are described in more detail in the section entitled “User Preference File” below.

Client 502 also includes a recommendation or matching engine 616 that drives the comparison of a particular user preference file with content description files associated with programs that are available for viewing.

When recommendation engine 616 determines that an attribute value in the user preference file matches an attribute value found in a content description file, the matching engine 616 can calculate an attribute score for the matching attribute. For example, an “actor” attribute in the user preference file may contain a value of “Steve Martin.” If an “actor” attribute in the content description file also contains the value of “Steve Martin,” then the “actor” attribute is designated as a matching attribute. An attribute score can then be assigned to the matching attribute, and one or more attribute scores assigned in a program can be used to calculate a program score for the program.

In one embodiment, recommendation engine 616 can make use of a significance file 618 when calculating the scores of a particular program. The significance file can contain significance values that are utilized in the calculation of program scores. Significance files are described in more detail below in the section entitled “Significance Files”.

The output of recommendation engine 616 are various score-based recommendations that can be provided on a user-by-user basis. Various nuances of scoring characteristics and techniques are described below in more detail.

Client 502 can also comprise a user interface (UI) switch 620 and a display 622 such as a television or monitor on which an EPG grid can be rendered. Although the display is shown as being a part of client 502, it is to be appreciated and understood that the display can be separate from the client, such as in the case where the client is embodied in a set top box (STB). The UI switch 620 is effectively used to switch between stored programs in the content buffer 606 and live programs emanating from a content source.

Content Description Schema

As noted above, to facilitate matching attribute values that the user likes (as indicated in their user preference file) with the attribute values of the content programs (as indicated in the content description files) a comprehensive and consistent description schema is used to describe the content. But one example of an exemplary content description schema that includes metadata categories that correspond to content attributes is described in U.S. patent application Ser. No. 10/125,260, incorporated by reference above.

User Preference File

The user preference file (UPF) is a global file that describes program attributes that the user likes. There is typically one user preference file per user, although users can have more than one user preference file for such things as representing multiple different user personas. In addition to describing the user's likes and dislikes in terms of program attributes, the user preference file can contain other global system attributes that relate to a particular user such as, for example, user interface setup options and programs the user always wishes to have recorded.

Against each program attribute is a preference number that can have a positive value (to indicate a level of desirability associated with content having that attribute), or a negative value (to indicate a level of undesirability associated with content having that attribute). In the example described below, preference numbers can range from −5 to +5.

The user preference file can be implemented in any suitable file format. In the example described below, the user preference file is implemented as an XML file and uses the same schema as the content description files (described in the section entitled “Content Description Files” below) that are used to describe the attributes of the content.

A representation of an exemplary content description schema as employed in the context of a user preference file appears directly below. This representation contains only an abbreviated selection of attributes and attribute values. Accordingly, a typical user preference file can contain more entries than those shown, and/or different attributes and/or attribute values.

<Person Entries>

<PersonName=“Julia Roberts” PersonRole=“Actor” Xpref=“−3”/>
<PersonChar=“Miss Marple” Xpref=“+1”/>
<PersonName=“Ron Howard” PersonRole=“Director” Xpref=“+5”/>

...
<Person Entries>
<Title Entries>

<TitleName=“Friday 13” Xpref=“+3”/>
<TitleName=“The Jerk” Xpref=“+5”/>

...
<Title Entries>
...

### Example User Preference File Schema

The user preference file is defined in terms of the same metadata attributes or categories that are used to describe the content in the content description files. The user preference file, however, adds one or more additional attributes that are specific to its associated user. A separate but compatible schema could be used for both the user preference file and the content description file. However, as a content description schema is an evolving concept that can add additional metadata categories over time, it is more desirable, for purposes of synchronization, to have the schemas remain synchronized. Thus, it is desirable to use the same schema for both the content description file and the user preference file.

The excerpt of the user preference file above includes tags that encapsulate various attributes and their associated values. In this specific example, “Person Entries” tags encapsulate attributes and values associated with particular individuals or characters. “Title Entries” tags encapsulates attributes and values associated with particular titles.

The “Person Entries” tag encapsulates a “Person Name” attribute that is used to identify a person such as an actor who is preferred by a particular user. A Person Name attribute value contains a character string such as an actor's name, e.g. “Julia Roberts.” This indicates that the user corresponding to the particular user preference file has a preference either a like or a dislike—for Julia Roberts in a particular context.

The “Person Entries” tag also encapsulates a “Person Role” attribute that identifies a particular function or context of the person identified in the “Person Name” attribute. This can allow a user to distinguish between actors who may also be directors in some programs. For example, the user may like movies in which Clint Eastwood stars, but may dislike movies in which Clint Eastwood directs. In this particular example, the “Person Role” attribute for Julia Roberts indicates that this entry pertains to Julia Roberts in the context of an actor, and not in some other context.

A preference attribute “Xpref=” is also provided for the “Person Name” and “Person Role” attributes and enables the user to enter a value or preference rating that indicates how much, relatively, the user likes or dislikes the value specified in the “Person Name” attribute for the context defined by the “Person Role” attribute. In this particular example, the user has indicated a value of “-3” for Julia Roberts in the context of an actor.

The “Person Entries” tag also encapsulates a “Person Character” attribute and value, as well as a preference attribute and rating associated with that “Person Character” attribute. The “Person Character” attribute enables a user to identify particular characters that the user likes or dislikes. In the present example, the Person Character attribute value comprises “Miss Marple”, and the preference rating associated with that character is “+1”. This indicates that the user slightly prefers programs in which this character appears.

There can be virtually any number of similar entries encapsulated by the “Person Entries” tag. For example, another “Person Name” attribute is defined for Ron Howard in the context of director and contains a preference rating of “+5”, which indicates a strong preference for programs directed by Ron Howard. Similarly, the “Title Entries” tags encapsulate “Title Name” attributes and associated values, as well as associated preference attributes and their associated ratings. In this example, a first “Title Name” attribute equals “Friday 13” having an associated preference attribute with a rating of “+2”. A second “Title Name” attribute equals “The Jerk” having an associated preference attribute with a rating of “+5”.

Whether attribute values actually match or not, and the extent to which attribute values match with attributes in the content description files depends on the particular entry type. For example, entry types can be used when exact matches are desired. This might be the case where a user has a particular preference for movie sound tracks in the French language. Yet other entry types can be used when an exact match is not necessarily needed or desired. Such might be the case, for example, when a user is interested in any of the movies in the “Friday the 13^{th}” series of movies. In this case, a match can be deemed to have occurred if the term “Friday 13” appears anywhere in the title of a movie.

Content Description File

Recall that each content folder, such as the one shown and described in FIG. 3, contains a content description file. In the present embodiment, the content description file uses the same schema as does the user preference file. The content of the files, however, can be different. An exemplary portion of a content description file is provided below. The content description file can contain more entries or attributes than those shown below. For example, attributes can include a title attribute, a content identifier attribute, a date of release attribute, a running time attribute, a language attribute, and the like.

<Person Entries>

<PersonName=“Russell Crowe” PersonRole=“Actor”/>
<PersonChar=“John Nash”/>

<Person Entries>
<Title Entries>

<TitleName=“A Beautiful Mind”/>

<Title Entries>

### Example Content Description File Schema

Accordingly, the “Person Entries” tag includes a “Person Name” attribute and value that are used to identify individuals associated with the content. In this particular case, the attribute can be used to designate actors appearing in a particular program. The “Person Entries” tag also includes a “Person Role” attribute and value that identifies a particular function or context of the person identified in the “Person Name” attribute. In this particular example, the “Person Name” and “Person Role” attributes for the content indicates that Russell Crowe is associated with the program in the context of an actor.

The “Person Entries” tag also encapsulates a “Person Character” attribute and value. The “Person Character” attribute identifies particular characters that appear in the program or movie. In the present example, the Person Character attribute value comprises “John Nash”.

Similarly, the “Title Entries” tags encapsulate a “Title Name” attribute and associated value which designates the title of the content. In this example, the “Title Name” attribute equals “A Beautiful Mind”.

As noted above, the user preference file and the content description file contain many of the same attributes. This is due to the fact that the files utilize the same content description schema to describe content attributes. This greatly facilitates the process of matching program attributes with a user's preferred attributes.

User Content Preference File

Various embodiments can also make use of user content preference files. A user content preference file is different from a user preference file. Recall that a user preference file is a global file that describes attributes that a user likes and dislikes. A user content preference file, on the other hand, is not a global file. Rather, the user content preference file is associated with each particular piece of content for each user or user preference file. The user content preference files are maintained in the content folder and describe how well a particular piece of content matches up with an associated user preference file. So, for example, if there are four users who use the particular client device, then there should be four User Preference Files that describe each user's likes and dislikes. For each content folder in the client system, then, there should be four User Content Preference files—one for each user describing how well this particular content matches up with the user's likes and dislikes.

User Content Preference files can facilitate the processing that is undertaken by the recommendation engine. Specifically, because of the large number of content folders, user preference files and the like, a recommendation engine can take a long time to execute. In practice, the recommendation engine is executed as a batch process. The results of the recommendation engine can be stored in the user content preference file so that they can be accessed by whatever application may need them.

In addition to indicating how well the particular content matches up with a user's user preference file, the user content preference file can include additional user-specific data that is particular to that piece of content. For example, if the user is a film buff and always wants to ensure that these particular movies are shown in a particular aspect ratio or using Dolby surround sound, such information can be located in the User Content Preference file.

The User Content Preference files can be used to generate human-readable reports that describe how the recommendation engine arrived at a particular score. This can be a desirable feature for more sophisticated users that can assist them in adjusting, for example, their program attribute preferences to refine the recommendations produced by the recommendation engine.

Significance File

Some program attribute matches that are found by the recommendation engine can be more important or significant than others. Significance values, as embodied in a significance file such as significance file 618 in FIG. 6, provide a way for the system to appropriately weight those things that are truly significant to a particular user.

A significance file is a global file that is used to store significance values that correspond to each attribute available in a program. Each significance value denotes a relative importance of the attribute with which it corresponds as compared to the other attributes. Use of significance values provides an appropriate weighting factor when determining whether a program should be recommended to a user or not. That is, when a recommendation engine compares a user's preference file with a content description file and finds a match between particular attribute values, the recommendation engine can multiply the preference rating for the matching attribute in the user's preference file with the corresponding significance value for that attribute in the significance. The product of this operation can then contribute to the overall score of a particular program for purposes of determining whether a recommendation should be made or not.

In accordance with one embodiment, the significance file uses the same schema as the content description file (so that everything stays in synch), and extends the schema by including an additional attribute (“XSignif”) that enables the user to express the significance of a particular attribute of the content description file. As an example, consider the excerpted portion of a significance file that appears directly below.

<Person Entries>

<PersonName=“ “ XSignif=“63”/>
<PersonChar=“ “ XSignif=“87”/>

<Person Entries>
<Title Entries>

<TitleName=“““ XSiqnif=“99”/>

<Title Entries>

### Example Significance File Schema

The above significance file excerpt includes a “Person Entries” tag and a “Title Entries” tag. These tags encapsulate many of the same attributes that appear in the user preference file and content description file.

Specifically a “Person Name” attribute is encapsulated by the “Person Entries” tag. Associated with the “Person Name” attribute is a significance attribute “XSignif” that is used to define the relative importance of a person associated with a particular piece of content as compared with other attributes. In this example, a significance value of “63” is assigned to the “Person Name” attribute. Assuming for purposes of this example that significance values range from zero to one hundred, a value of “63” indicates that a match of this attribute is generally important to the user.

A “Person Character” attribute is also encapsulated by the “Person Entries” tag, and the corresponding significance attribute “XSignif” of “87” indicates that a match of this attribute is more important to the calculation of the program score than a match of the “Person Name” attribute.

A “Title Name” attribute is encapsulated by the “Title Entries” tag and, in this example, an associated significance attribute “XSignif” of “99” indicates that a match of this attribute is even more important than a match of the “Person Character” attribute.

It should be noted that the significance values could be stored in the user preference files along with each entry therein, thereby making the significance 1 values user specific rather than system wide. They could even be associated with the particular preferences, however, doing so would require redundant entries since some attributes may be repeated with different attribute values. For example, a user preference file may include fifty actors' names that a user prefers to see. If the significance values were to be included in the user preference file associated with particular preferences, then each of the fifty entries for actors' names would have to include the same significance value. Thus, by virtue of the fact that the significance file is a global file, such redundancies can be avoided.

Additionally, it should be appreciated that it is not necessary for the user to create and/or have control over the significance file. Rather, another entity such as a content provider may assign the significance values for a particular client system. While such an implementation would not provide as close a fit with each user's personal preferences, it would relieve the user from having to individually do the work.

As an example of how a client device or system can employ a significance file and significance values, consider the following. Assume that in a user's preference file the user includes the same rating or preference value (e.g. +5) for the “Title Name” and “Person Character” attributes. For example, perhaps the “Title Name” of concern is the “Seinfeld” show and the “Person Character” of interest is the Kramer character. Thus, in this instance, the user really likes the Seinfeld show and the Kramer character. Notice in the excerpted portion of the significance file that appears above, the “Title Name” attribute has a significance value of “99”, while the “Person Character” attribute has a significance value of “87”. Thus, although the user may enter the same preference value for the Title Name attribute value and the Person Character attribute value (i.e. +5) because the user strongly prefers both, all other things being equal, by using the significance file the system would determine that this user prefers a Seinfeld episode that features the Kramer character (with a corresponding score of 5*87+5*99=930) over a Seinfeld episode that does not feature the Kramer character (with a corresponding score of 5*99=495).

For many of the program attribute types, the significance file can have multiple numbers, each tagged with the type of match to which they relate. The most commonly used tags can be “Full” and “Part” which refer respectively to a full match or just a partial match. Finding a keyword within a plot abstract is an example of a partial match.

Running the Recommendation Engine

Typically, the recommendation engine is run or otherwise executed for every piece of content for every user on the client system. Needless to say, this can involve a fairly large amount of processing for the client system. Various strategies can be used on the client to effectively hide this processing time. This can be particularly important in the context of client devices that do not employ high end processors.

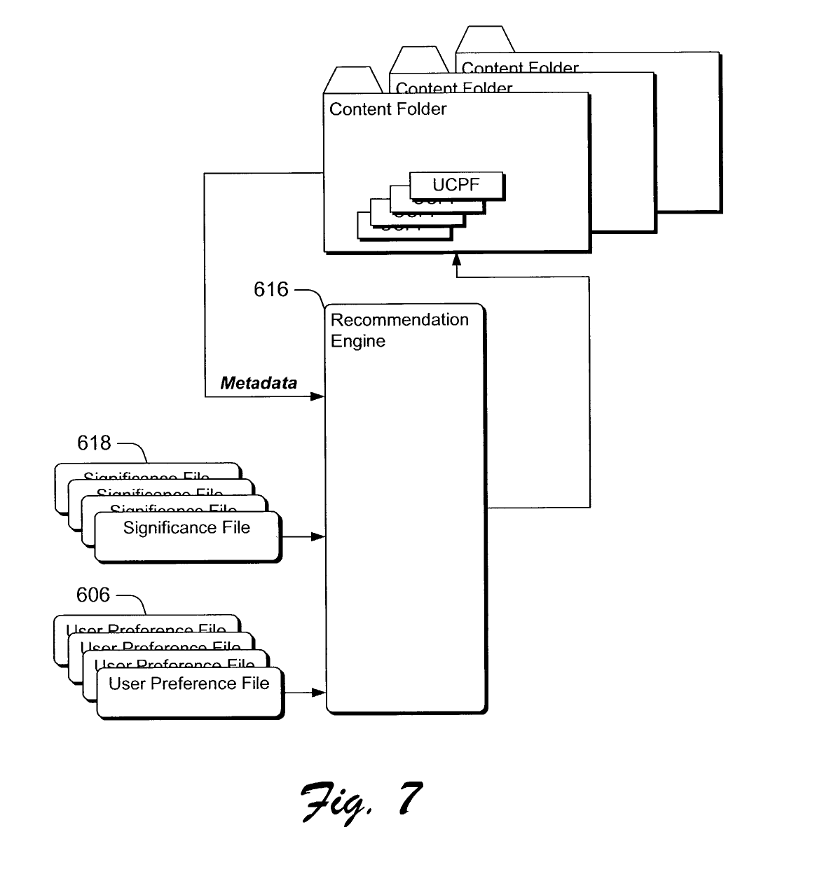

As an example, consider FIG. 7 which illustrates, in somewhat more detail, the processing that can take place at the recommendation engine 616. Typically, there are a number of different inputs to the recommendation engine. Here, the inputs can include the metadata from each of the content folders, the input from each user's associated significance file 618, and the input from each user's preference file 606. For each piece of content that the client receives (i.e. for each content folder), the recommendation engine is run with these inputs. The recommendation engine 616 processes inputs and then provides an output that includes, among other things, the scores for the various programs, for each user, that are slated for broadcasting during the next period of time. This data can be provided by the recommendation engine into user content preference files (UCP files) that are contained in each of the content folders. Additionally, the recommendation engine's output is also used to make recommendations for the various users via the EPG that is generated and displayed for the users. Those programs that more closely match a particular user's likes can be displayed more prominently than those program that do not closely match a user's likes.

In accordance with one embodiment, recommendation engine 616 can be run or executed as the content description information (i.e. the content folders) are downloaded from the server. Downloading of the content folders can be scheduled such that the content folders are downloaded at a time when the users are not likely to be using the client system, e.g. very early in the morning. Typically, content folders that are downloaded are associated with content that is to be broadcast up to a couple of weeks into the future. Downloads can be scheduled for once a day such that if for some reason a download does not happen on a particular day, the next day's download can catch up. In practice, it is usually sufficient for downloads to occur at least once a week so that the user's experience is not disrupted. Accordingly, scheduling downloads for every day can provide plenty of room to account for such things as bandwidth limitations and the like.

Thus, typically, the recommendation engine can be scheduled to run every night. In some situations, it can be desirable to immediately run the recommendation engine if, for example, something in the client system changes that would make running the recommendation engine desirable. For example, assume that a user is watching a particular program and something or someone in the program catches their eye. Perhaps they notice a new actor whom they really like. The user may opt to update their user preference file to reflect that they would like to have more recommendations made for any programs in which this particular actor appears. Here, then, it can be desirable to immediately run the recommendation engine to incorporate the user's new changes in their user preference file. This can provide the user with immediate feedback and recommendations. In practice, however, this may be unnecessary because the user's change may not necessarily change the overall scores very much.

Sorting the Scores

During the download of content description data (i.e. content folders), recommendation engine 616 calculates a score for each program. At the end of the complete process, the recommendation engine can sort the scores for all of the programs so that it is later able to display a sorted list of recommendations to the user. This list of sorted scores can be kept in a separate scores file. The scores file can include a list of the MCIDs for each of the programs and the corresponding score for each MCID. Each user can have a separate scores file that contains their own scores for the various programs. Using only an MCID is sufficient in this case because with the MCID, all other relevant information pertaining to a particular program can be accessed.

The scores file can be stored as part of the user preference file, or in an accompanying file that is associated with the user. The latter would go far to ensure that the user preference file does not become too bloated.

Privacy Issues

Because the user preference files and scores files contain sensitive information, various protections can be utilized to ensure that the user preference files and, if a separate file—the scores files—are protected.

To protect the user preference and scores files, the files can be encrypted and access to the files can be via password. Any suitable encryption techniques can be utilized such as DES or AES security techniques. Other methods of protection can be utilized such as storing the files on a removable smartcard.

Relative Scoring

As noted above, each program that is to be broadcast in a forthcoming schedule is given a score by the recommendation engine. The actual score that each program receives is not as important as the score's significance relative to all of the other scores. That is, it is more useful to assess the scores of each program relative to the scores for the other programs. Thus, it can be advantageous to translate each program's actual score into a relative score so that its importance to the individual users can be ascertained relative to the other programs that are to be broadcast.

In accordance with one embodiment, the recommendation engine computes a score for each of the programs that are to be broadcast. The recommendation engine then takes this score and computes a relative score that provides a measure of how one particular program relates all of the other programs that are to be broadcast. One way of computing a relative score is to divide each program's individual score by the highest score found for any program in the forthcoming schedule. To facilitate this calculation, the recommendation engine can, at the conclusion of the download and metadata matching processes, determine the highest score and save this score in a global location, e.g. in a particular user's user preference file. As further individual scores are computed for each of the programs for each of the users, each program's relative score can be computed as well.

It can be advantageous to translate each program's relative score into a useful visual display that can be readily utilized by a user for selecting programs. For example, a star rating system can be utilized. One way of implementing a star rating system can be as follows. Programs that receive a negative score (and hence are not desirable from a user's standpoint) will not receive a recommendation star. Similarly, programs that receive scores that are less than typically about half of the highest score will not receive a recommendation star. Various thresholds can be used to ascertain how many stars a program is to receive. It can be desirable for the thresholds associated with the different star ratings to be user programmable so that individual users can define how stars are to be assigned. As an example, consider the following exemplary threshold settings and associated stars:

| 0-50% (and negative scores) | No star |
|---|---|
| 50-60% | One star |
| 60-70% | Two stars |
| 70-80% | Three stars |
| 80-900% | Four stars |
| 90-1000% | Five stars |

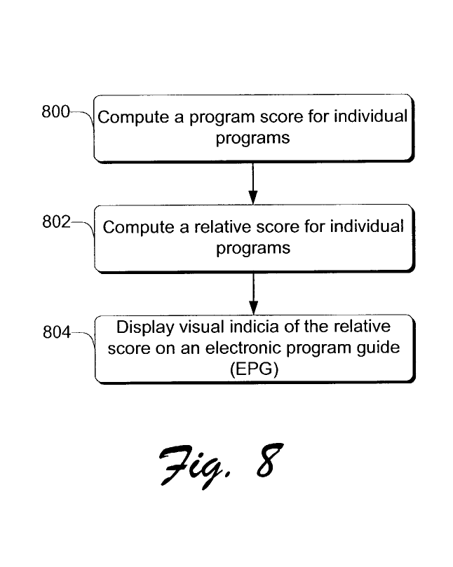

FIG. 8 is a flow diagram that describes steps in a method in accordance with one embodiment. The method can be implemented in any suitable hardware, software, firmware or combination thereof. In the illustrated example, the method can be implemented in connection with an EPG system such as the one discussed above.

Step 800 computes a program score for individual programs that are to be represented in an electronic program guide. Program scores can be computed in any suitable way. One way of computing program scores is described in this document and the others that have been incorporated by reference above. In those systems, computation of the program scores is performed by a recommendation engine that can compute scores as a function of metadata that describes media content and preferences that have been expressed by users in terms of a user preference file. Step 802 computes, from the program score for each program, a relative score for that program. The relative score provides a measure of how well a particular program relates to the other programs that are to be broadcast. One way of computing a relative score is described just above. Step 804 then displays visual indicia of the relative score on an EPG. This step can be implemented by rendering an EPG and providing, within or associated with individual cells of the EPG, the visual indicia for an associated program. Any suitable visual indicia can be utilized. For example, the visual indicia can comprise a number that reflects the relative score, one or more symbols (such as a star or a number of stars), or a color that is associated with or used to accent individual cells (e.g. brightly colored cells indicate highly recommended programs, lesser colored cells indicate program of moderate or little interest, and blandly colored or uncolored cells indicate programs that are not recommended).

As an example of an EPG that can support visual indicia that is indicative of a program's relative score and hence, its desirability for a particular user, consider FIG. 9. There, an EPG 900 includes multiple cells 902 that contain information that pertains to various programs have been or are to be broadcast. Notice that individual cells include two different types of visual indicia. For example, visual indicia 904 comprises symbols that indicate or otherwise represent a particular program's relative score. Thus, in this example, four symbols indicates a program that is more desirable than a program having two symbols. Additionally, in this example, visual indicia 906 comprises a numerical value that is itself the program's relative score.

Thus, rather than having to look at each particular cell for upcoming programs, the system gives the user a head start by providing visual indicia at which a user can quickly glance to make a decision on whether the program is likely to be of interest or not.

Visual Indicia in the EPG to Facilitate Navigation

In addition to the visual indicia that is provided above to facilitate a user's browsing activities, other visual indicia can be provided in connection with an EPG to facilitate a user's assimilation of information contained in the EPG.

For example, when a user browses an EPG grid that has many hundreds of channels listed for a schedule that typically spans two weeks, there is no practical way that the user will have time to read the text associated with each program. In practice then, what is needed is a way to make it easier for the user's eye to be attracted to something of interest.

Thumbnail cover-art pictures or other images associated with the program cells of the EPG grid can enable a user to very quickly assimilate information about the programs referenced by the EPG. A single small picture can, at a glance, tell the user who is in the program, what the program is about, and much much more.

As an example, consider again FIG. 9 where various images 908 are provided within the EPG and are associated with the particular programs that are referenced in the corresponding cell. The various images can constitute any suitable images that can be associated with programs appearing in the EPG grid. For example, program-specific images can include images of individuals appearing in the program, images of scenes from the program, images of program cover art (such as movie cover art), genre-related images, and the like. These images are non-textual images which, in the context of this document is intended to mean images that are not predominately textual in nature.

Once a user sees a particular thumbnail image of interest in the grid, they can simply move their cursor over that particular cell of the grid in order to get additional information about the program, and perhaps a larger view of the picture. For example, in FIG. 9, the user has moved their cursor over the EPG cell that corresponds to the movie “Next Friday”. Notice that responsive to moving their cursor over the corresponding cell, a window 910 is rendered and includes additional information about the “Next Friday” movie which includes rating information, content assessment (i.e. nudity, violence and the like), as well as a short summary of the movie.

Determining Favorite Channels

Reducing the number of channels displayed in an EPG grid can constitute an important way to reduce the amount of information that is displayed for a user and thus, reduce the user's information overload. In accordance with one embodiment, favorite channels can be ascertained and, when an EPG grid is rendered, the favorite channels can be displayed in a manner that makes them readily apparent to the user. The favorite channels can be those of individual users, and/or system-wide favorites.

There are a number of approaches that can be utilized to select a user's favorite channels. One approach is to allow the user to set or clear check boxes next to a list of available channels. While this can enable a user to personally define those channels that are their favorites, in practice, most users would not typically take the time to go through this exercise.

Accordingly, there are some automatic approaches that do not require a user to be directly involved in the favorite channels selection process.

For example, favorite channels can be determined by analyzing the viewing log associated with the client device. If a particular channel has been the subject of a large amount of user viewing, then this channel is likely to constitute one of a user's favorite channels. The channels can then be ordered in an EPG according to the frequency with which they have been viewed by a particular user. A threshold measure can be applied to ensure that only a selected number of channels are selected so as to make them the user's favorites.

While this approach constitutes a desirable first step, it may suffer from problems associated with the voluminous number of channels that are available from which a user can select. That is, the channels that the user has watched in the past may well constitute an artificial subset of the available channels, and may not really reflect the channels that the user would really like to have on their favorites list.

In accordance with another embodiment, the processing capabilities of the recommendation engine can be utilized to provide a list of favorite channels that more closely mirrors the user's likes as defined in their user preference file.

Specifically, as described above, the recommendation engine can calculate a score for programs that are broadcast on individual channels. Advantageously, this can be done for all of the programs on all of the channels. After calculating the scores for each channel's programs, the recommendation engine can determine the average score for all the programs on each particular channel. The channels can then be ordered, in the EPG, according to their average program score. A threshold measure can be applied to ensure that only a selected number of channels are selected so as to make them the user's favorites. The threshold measure can be user adjustable. This approach can be applied on a user-per-user basis, or on a system wide basis.

Once the favorite channels have been ascertained, the favorite channels can be displayed in numerical order, or they can be displayed in stack ranking order, i.e. the best favorite at the top, then the second best, and the like.

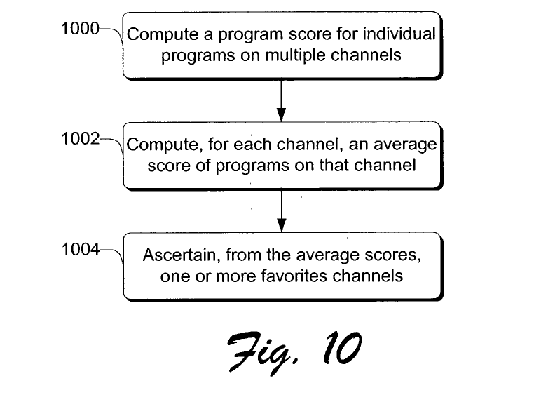

FIG. 10 is a flow diagram that describes steps in a method in accordance with one embodiment. The method can be implemented in any suitable hardware, software, firmware or combination thereof. In the illustrated example, the method can be implemented in connection with an EPG system such as the one discussed above.

Step 1000 computes a program score for individual programs on multiple channels. Any suitable method for computing scores can be utilized. But one example of how to compute scores is given above. In order to provide an accurate assessment, it is desirable to compute scores for each of the programs on each channel. Step 1002 computes, for each channel, an average score of programs on that channel. This can be done by simply adding the program scores for each channel's programs and dividing by the total number of programs on that channel. Step 1004 ascertains, from the average scores, one or more favorites channels. In the example above, the channels with the highest average program scores can be selected as the favorite channels. As noted above, selection of channel favorites can take place on a system-wide basis or on a user-per-user basis.

User Ratings

In accordance with another embodiment, the EPG can include explicit user ratings that can be provided by individual users. The user ratings can indicate whether the particular user liked or did not like a particular program. Providing user ratings can be useful in the EPG context so that particular programs that a user did not like may be excluded from the EPG grid the next time the program is slated to be broadcast.

Thus, in accordance with this embodiment, the system can receive a user's input that rates one or more programs that appear in the electronic program guide. Input can be received via any suitable user interface component. The system can then render an electronic program guide that incorporates the user's input. For example, the system can render an electronic program guide that provides some visual indicia that represents the user's rating (e.g. 1-5 user-provided stars). The system can also render an electronic program guide that excludes one or more programs that were not favorably rated by the user. For example, the user may rate a program as a “1-star” program—meaning that the user did not like the program at all. The system can then take steps to exclude this program from future electronic program guides that are rendered for the user.

User-definable, Score-Based Program Assessment and EPG Display

As noted above, one of the basic problems with many EPGs is that they simply contain too much information. Users can benefit greatly by having a mechanism by which they can remove programs and associated data from an EPG so that while they browse the EPG, they are exposed to programs in which they are likely to be interested.

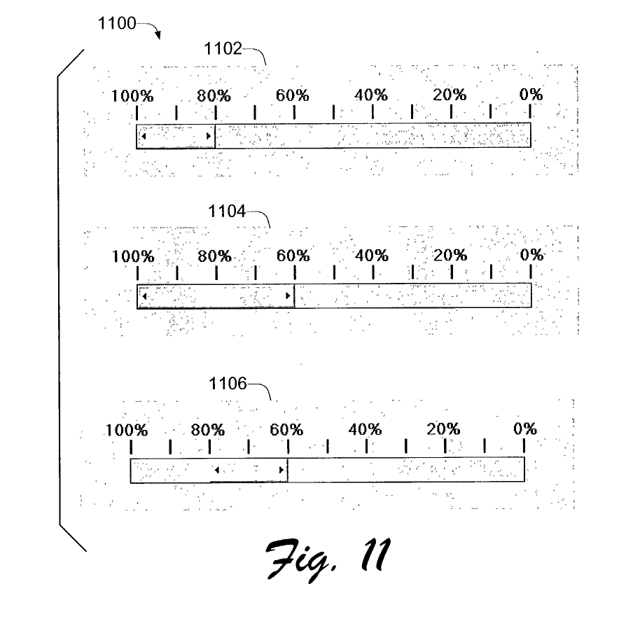

FIG. 11 shows an exemplary user interface 1100 in the form of a slider that can be utilized by a user to define the media content or programs that ultimately appear in an EPG grid. The illustrated slider can be implemented as part of the EPG application, or can comprise part of the UI software that can be utilized in connection with an EPG application.

One way in which the slider can be configured to operate is as follows. Recall that the recommendation engine can calculate a score for every program in a forthcoming TV schedule (i.e. typically about two weeks into the future). The recommendation engine can also calculate a relative score for each of the programs as described above. The relative score provides a measure as to how well the particular program compares, in terms of what individual users like or prefer, to other programs in the schedule.

A slider or some other UI component can provide the user with an opportunity to define those programs that they would like to have displayed on an EPG. For example, a user may wish to have an EPG generated that contains only the top 20% of the programs for the upcoming schedule. Thus, the user can set the slider to reflect that they wish to see just the top 20% of the upcoming programs in an EPG. Slider 1102 indicates such a slider that has been set by the user. When an EPG is constructed by the EPG system, the user's input, via the slider, is received by an EPG application and processed to render the appropriate EPG having only the 20% of the programs on the schedule.

Once a user reviews these programs, they may decide that nothing in the EPG interests them. Accordingly, they can adjust the range of values that pertain to the programs that are to be reflected in the EPG. For example, notice that slider 1104 has a maximum position defined at “100%” and a minimum position defined at “60%”. This will, in turn, pick up the next 20% of programs for inclusion in the EPG.

Notice in this example though that the user has already reviewed the first 20% of the programs and has found nothing of interest. Accordingly, the maximum and minimum positions of the slider can be configured to be independently adjustable so that a user need not have programs that they have already reviewed in their EPG. As an example, consider slider 1106 which defines a range between 60% and 80%. Here, assume that the user has already reviewed the top 20% of the programs on the schedule and has not found any programs of interest. Accordingly, by adjusting the maximum position of the slider to the “80%” value, the user will exclude those programs from the EPG that they have already reviewed.

The effect of filtering down the number of programs displayed on an EPG is to produce either a sparsely populated EPG grid, or a reduced list size depending on whether the EPG is in a grid display mode or a list display mode.

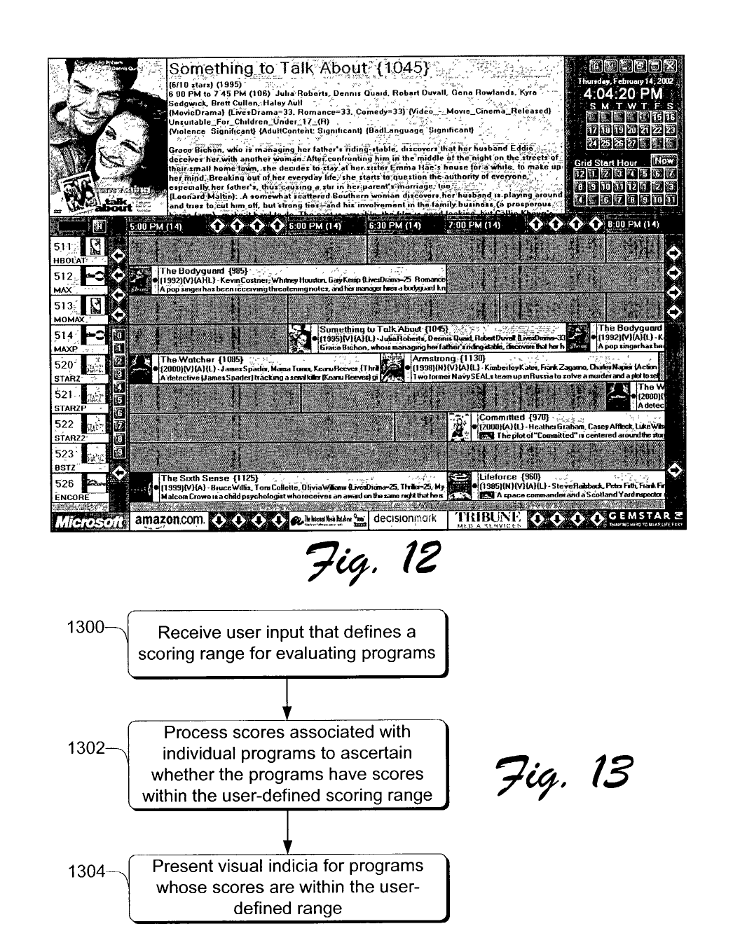

FIG. 12 shows an example of a sparsely populated EPG grid that has been generated in response to a user manipulating the FIG. 11 sliders. Notice that there are a number of blank cells that contain no program information. These blank cells correspond to programs that have been removed by the EPG system as a result of the user's input.

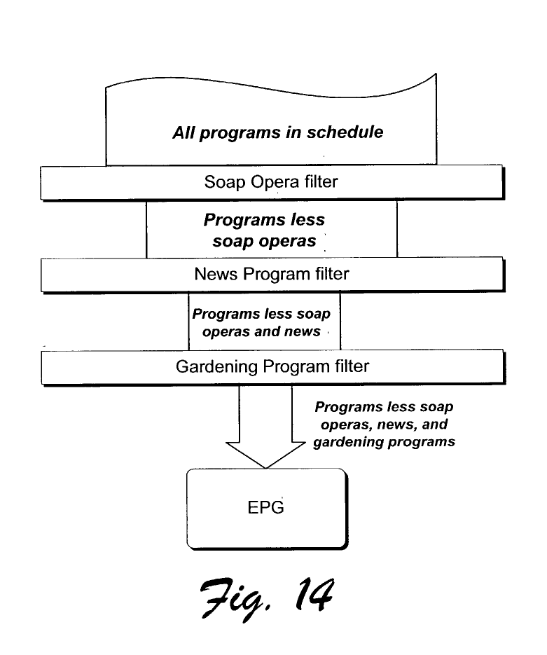

FIG. 13 is a flow diagram that describes steps in a method in accordance with one embodiment. The method can be implemented in any suitable hardware, software, firmware or combination thereof. In the illustrated example, the method can be implemented in connection with an EPG system such as the one discussed above.

Step 1300 receives user input that defines a scoring range for evaluating programs that can appear in an electronic program guide. The user input can be received using any suitable technique. But one example of how the user's input can be received is described above in the form of a user interface component comprising a slider. However, any suitable user interface component can be used. Step 1302 processes scores associated with individual programs to ascertain whether the programs have scores within the user-defined range. In the example above, the scores that are processed constitute each program's relative score. Thus, if the highest scoring program has a score of 1000 and a particular program of interest has a score of 950, that program's relative score is 950/1000=0.95 or 95%.

Step 1304 presents visual indicia for programs whose scores are within the user-defined range. In the present example, assume that the user has set the slider to the settings shown by slider 1102 in FIG. 11. This slider setting will result in programs that have relative scores over 80% being represented in an EPG. Since the present program has a relative score of 95%, the program will be represented in an EPG that can be rendered for the user.

Any suitable visual indicia can be presented. For example, the visual indicia can comprise a list of programs that meet the criteria. Alternately, an EPG can be rendered that includes only those programs that meet the criteria. An example of such an EPG is shown in FIG. 12.

Cumulative Filter Application

In accordance with the described embodiments, there are many different program attributes that can serve as a basis for a user to conduct a search or filter operation. Exemplary attributes are found in the content description schema. As the content description schema can be an evolving entity, the richness of the attributes that can form the basis of a search or filtering operation is not fixed. Examples of some attributes are given above. Still further examples of various program attributes are provided in the applications that are incorporated by reference above.

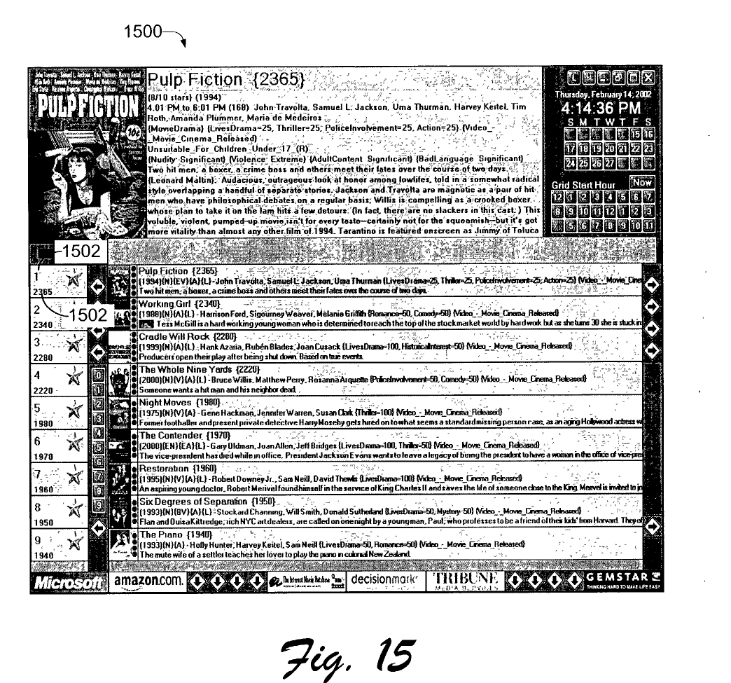

In accordance with this embodiment, a user can select one or more filters that can be used to filter programs and reduce the number of programs that are ultimately represented in the EPG. The user can make filter selections through any suitable user interface. As an example, consider FIG. 14. There, a user has selected a soap opera filter, a news program filter, and a gardening program filter. Thus, the EPG that is ultimately rendered for the user will comprise all of the programs in the upcoming schedule except for those programs that are soap operas, news programs, and gardening shows. The resultant EPG that is rendered will consist of a pared down EPG similar to the one appearing in FIG. 12.

In accordance with this embodiment, the system can cumulatively apply filters until only those program types of interest are reflected in the EPG. It is interesting to note that the user is not reducing the amount of information available for the programs in which they are interested, but rather they are reducing the number of programs for which information is displayed in the EPG.

Recommendation Lists

One of the ways that a user's experience can be enhanced is by reducing the amount of information to which a user is exposed in an EPG. Several of the embodiments described above have this desirable effect. The user's experience can be further enhanced by enabling them to see a display of those programs that scored the highest of all programs that are offered in the upcoming schedule. This way, the user can readily identify, without searching through the entire EPG, those programs that have best met their preferences as set forth in their user preference file. Recommendation lists constitute one way of enhancing the user's experience in this regard. Recommendation lists can, however, constitute much more.

Recall from FIG. 3 that many client systems can include a content buffer 606 which can provide the recording component of a PVR (Personal Video Recorder) system. The content buffer can thus record programs that a user would like to view at some later time. Now consider the role of the recommendation engine in concert with the content buffer. The recommendation engine can ascertain through its score-based processing, those programs that are most likely desired by a user. The content buffer can provide the means by which such programs can be recorded for the user to view at a later date. Accordingly, together, the recommendation engine and the content buffer can reduce the importance of the role of the channel and time at which the program can be viewed. When considered together, the recommendation engine and the content buffer relegate the roles of channel and time to implementation details.

Given this reduced role of channel and time, it can become unnecessary, in some instances, to even present programs and their corresponding broadcast times in an EPG grid. Rather, because the recommendation engine has already scored each of the programs in the schedule, the recommendation engine can prepare an ordered list that lists and ranks the programs in terms of the overall scores that the programs have received. Those programs that receive the highest score can be listed at the top of the list, followed by lesser ranked programs. Further, this list can be presented to the user in an EPG-like display that includes all of the interesting and useful information and images mentioned above.

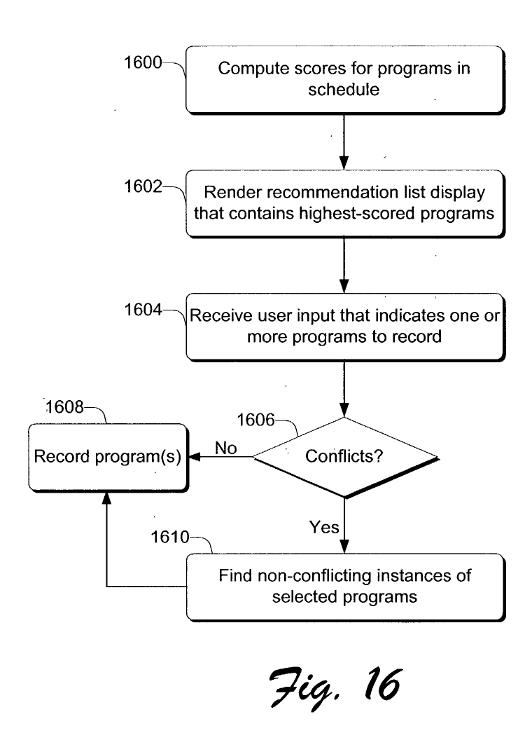

As an example of an EPG-like recommendation list display, consider FIG. 15 which shows a recommendation list display 1500 that includes a number of different programs that have been ranked by the recommendation engine. Notice in the far left column, each movie has an associated numerical rank 1502 and its overall score 1504. Here, for this particular user, the movie “Pulp Fiction” has the highest score so it is listed first. Notice also that the individual cells associated with each program can contain the image or thumbnail art for that program.

Once the recommendation list has presented the ranked programs in its EPG-like display, the user can simply browse the selections and make decisions on which programs they would like to view. The user's experience can be further enhanced by selecting one or more programs for recording so that the programs can be viewed at a later date. This way, it is unimportant to the user when a particular program is going to be broadcast. Rather, they can simply click on a particular program to select it for recording. The system will then ascertain when the program is next going to be broadcast and will record the program for the user. This does not require any user involvement (other than selecting the program or programs) and the user does not need to know when the program was broadcast or on what channel. As far as the user is concerned, the program will show up on the PVRs list of recorded shows and they will be able to watch it whenever they wish.

It should be noted that because of the underlying content identification mechanisms, it is possible for the system to resolve tuner conflicts involved in recording the requested program. Specifically, the user is simply selecting a piece of content, not a particular instance of that content. Thus, the system is free to find the most convenient instance to record, and thereby avoid tuner clashes.

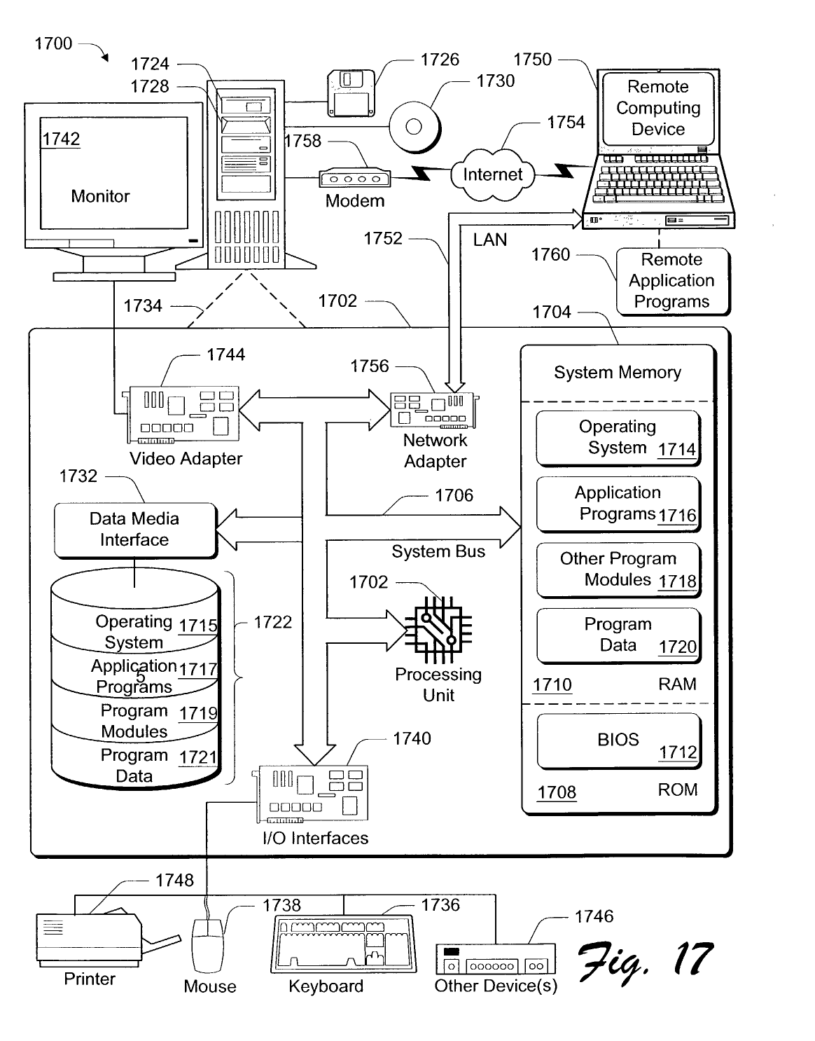

FIG. 16 is a flow diagram that describes steps in a method for recommending programs to a user in accordance with one embodiment. The method can be implemented in any suitable hardware, software, firmware or combination thereof. In the illustrated example, the method can be implemented in connection with an EPG system such as the one discussed above.

Step 1600 compute scores for programs in the schedule. Any suitable method for computing the scores can be utilized, examples of which are given above. This step can be implemented by a suitably configured recommendation engine such as the ones described above. Step 1602 renders a recommendation list display that contains the highest-scored programs. Any suitable display can be rendered. In the present example and as set forth in FIG. 15, a recommendation list is displayed that includes information about the ranked programs (including thumbnail art), the programs' ranks and their overall scores. Step 1604 receives user input that indicates one or more programs that a user wishes to record. Any suitable input can be received using any suitable input mechanism. For example, a user can simply click on a particular program to have it recorded. Step 1606 determines whether any of the programs selected by the user (or any other users of the system) conflict with one another. A conflict can occur when two instances of different programs have overlapping times when they are to be broadcast. If there are no conflicts between selected programs, step 1608 records the program at the appropriate time and then can later present a list to the user of the recorded programs. If, on the other hand, step 1606 determines that one or more of the selected programs conflict with one another, then step 1610 finds non-conflicting instances of selected programs and records them.

Accordingly, recommendation lists can enhance a user's experience by ensuring that users are notified of programs that are of interest to them, and given an opportunity to select the programs for recording so that the programs can be viewed at a later date or time.

Recently Watched Programs

As another measure to enhance the user's experience, information that pertains to programs that a user has most recently watched can be provided to the user or alternately, those shows can be hidden from the user.

For example, in the EPG context, if a user has recently viewed (e.g. within the past week and/or during the current pendency of the television schedule) a particular program, the program can be highlighted in such a way that as a user scans the EPG grid, they can simply skip over the selection. Such programs can be highlighted in any suitable way, examples of which are given above. This is an example where additional information is provided to the user.

Information pertaining to recently viewed programs can, however, be hidden from the user for purposes of enhancing their experience. Assume, for example, that the system prepares a recommendation list, such as the recommendation list in FIG. 15. Assume also that the user viewed the movie “Pulp Fiction” two days ago. Accordingly, it may not be as important to have “Pulp Fiction” displayed at the top of the recommendation list, even though it is the user's top rated program. Accordingly, in this instance, the program can be removed from the recommendation list so that the user only sees those programs that are ranked the highest and which they have not viewed for a while. Thus, for many users, the intersection of programs that best match with the user's preferences and the set of programs that they have not recently watched, can constitute the best bets as to the best choice of programs to recommend or display.

Exemplary Computer Environment

The various components and functionality described herein can be implemented with a number of individual computers that serve as client devices. FIG. 17 shows components of a typical example of such a computer generally at 1700. The components shown in FIG. 17 are only examples, and are not intended to suggest any limitations as to the scope of the claimed subject matter.

Generally, various different general purpose or special purpose computing system configurations can be used. Examples of well known computing systems, environments, and/or configurations that may be suitable for use in implementing the described embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Various functionalities of the different computers can be embodied, in many cases, by computer-executable instructions, such as program modules, that are executed by the computers. Generally, program modules include routines, programs, objects, components, data structures, etc. that perform particular tasks or implement particular abstract data types. Tasks might also be performed by remote processing devices that are linked through a communications network. In a distributed computing environment, program modules may be located in both local and remote computer storage media.

The instructions and/or program modules are stored at different times in the various computer-readable media that are either part of the computer or that can be read by the computer. Programs are typically distributed, for example, on floppy disks, CD-ROMs, DVD, or some form of communication media such as a modulated signal. From there, they are installed or loaded into the secondary memory of a computer. At execution, they are loaded at least partially into the computer's primary electronic memory. The invention described herein includes these and other various types of computer-readable media when such media contain instructions programs, and/or modules for implementing the steps described below in conjunction with a microprocessor or other data processors. The invention also includes the computer itself when programmed according to the methods and techniques described below.

For purposes of illustration, programs and other executable program components such as the operating system are illustrated herein as discrete blocks, although it is recognized that such programs and components reside at various times in different storage components of the computer, and are executed by the data processor(s) of the computer.

With reference to FIG. 17, the components of computer 1700 may include, but are not limited to, a processing unit 1702, a system memory 1704, and a system bus 1706 that couples various system components including the system memory to the processing unit 1702. The system bus 1706 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as the Mezzanine bus.

Computer 1700 typically includes a variety of computer-readable media. Computer-readable media can be any available media that can be accessed by computer 1700 and includes both volatile and nonvolatile media, removable and non-removable media. By way of example, and not limitation, computer-readable media may comprise computer storage media and communication media. “Computer storage media” includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1700. Communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

The system memory 1704 includes computer storage media in the form of volatile and/or nonvolatile memory such as read only memory (ROM) 1708 and random access memory (RAM) 1710. A basic input/output system 1712 (BIOS), containing the basic routines that help to transfer information between elements within computer 1700, such as during start-up, is typically stored in ROM 1708. RAM 1710 typically contains data and/or program modules that are immediately accessible to and/or presently being operated on by processing unit 1702. By way of example, and not limitation, FIG. 17 illustrates operating system 1714, application programs 1716, other program modules 1718, and program data 1720.

The computer 1700 may also include other removable/non-removable, volatile/nonvolatile computer storage media. By way of example only, FIG. 17 illustrates a hard disk drive 1722 that reads from or writes to non-removable, nonvolatile magnetic media, a magnetic disk drive 1724 that reads from or writes to a removable, nonvolatile magnetic disk 1726, and an optical disk drive 1728 that reads from or writes to a removable, nonvolatile optical disk 1730 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1722 is typically connected to the system bus 1706 through a non-removable memory interface such as data media interface 1732, and magnetic disk drive 1724 and optical disk drive 1728 are typically connected to the system bus 1706 by a removable memory interface such as interface 1734.

The drives and their associated computer storage media discussed above and illustrated in FIG. 17 provide storage of computer-readable instructions, data structures, program modules, and other data for computer 1700. In FIG. 17, for example, hard disk drive 1722 is illustrated as storing operating system 1715, application programs 1717, other program modules 1719, and program data 1721. Note that these components can either be the same as or different from operating system 1714, application programs 1716, other program modules 1718, and program data 1720. Operating system 1715, application programs 1717, other program modules 1719, and program data 1721 are given different numbers here to illustrate that, at a minimum, they are different copies. A user may enter commands and information into the computer 1700 through input devices such as a keyboard 1736 and pointing device 1738, commonly referred to as a mouse, trackball, or touch pad. Other input devices (not shown) may include a microphone, joystick, game pad, satellite dish, scanner, or the like. These and other input devices are often connected to the processing unit 1702 through an input/output (I/O) interface 1740 that is coupled to the system bus, but may be connected by other interface and bus structures, such as a parallel port, game port, or a universal serial bus (USB). A monitor 1742 or other type of display device is also connected to the system bus 1706 via an interface, such as a video adapter 1744. In addition to the monitor 1742, computers may also include other peripheral output devices 1746 (e.g., speakers) and one or more printers 1748, which may be connected through the I/O interface 1740.

The computer may operate in a networked environment using logical connections to one or more remote computers, such as a remote computing device 1750. The remote computing device 1750 may be a personal computer, a server, a router, a network PC, a peer device or other common network node, and typically includes many or all of the elements described above relative to computer 1700. The logical connections depicted in FIG. 17 include a local area network (LAN) 1752 and a wide area network (WAN) 1754. Although the WAN 1754 shown in FIG. 17 is the Internet, the WAN 1754 may also include other networks. Such networking environments are commonplace in offices, enterprise-wide computer networks, intranets, and the like.

When used in a LAN networking environment, the computer 1700 is connected to the LAN 1752 through a network interface or adapter 1756. When used in a WAN networking environment, the computer 1700 typically includes a modem 1758 or other means for establishing communications over the Internet 1754. The modem 1758, which may be internal or external, may be connected to the system bus 1706 via the I/O interface 1740, or other appropriate mechanism. In a networked environment, program modules depicted relative to the computer 1700, or portions thereof, may be stored in the remote computing device 1750. By way of example, and not limitation, FIG. 17 illustrates remote application programs 1760 as residing on remote computing device 1750. It will be appreciated that the network connections shown are exemplary and other means of establishing a communications link between the computers may be used.

Conclusion

The systems and methods described above can greatly enhance a user's experience by not only reducing the amount of information to which a user is exposed, but by presenting the information in such a way that is tailored for and meaningful to individual users.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. A method comprising:
computing a program score for individual programs that are to be represented in an electronic program guide;
computing, from the program scores, a relative score for individual programs, the relative scores providing a measure of how well a particular program relates to the other programs that are to be represented in the electronic program guide; and
displaying visual indicia of the relative scores of individual programs on the electronic program guide.

2. The method of claim 1, wherein the act of computing the program scores is performed by a recommendation engine that resides on a client device.

3. The method of claim 1, wherein the act of computing the program scores comprises computing the scores as a function of metadata that describes the programs and user preferences.

4. The method of claim 1, wherein the act of displaying comprises providing the visual indicia within a cell of the electronic program guide.

5. The method of claim 1, wherein the act of displaying comprises selecting the visual indicia based upon one or more thresholds associated with the relative scores.

6. The method of claim 5, wherein the visual indicia comprises one or more symbols.

7. The method of claim 5, wherein the visual indicia comprises a number.

8. The method of claim 5, wherein the visual indicia comprises one or more symbols, individual collections of symbols representing a range of relative scores.

9. The method of claim 5, wherein the visual indicia comprises a color associated with a cell of the electronic program guide that corresponds to the program.

10. The method of claim 1, wherein the act of computing the relative scores comprises dividing an individual program score by the highest score for any of the programs.

11. The method of claim 1 further comprising receiving input from one or more users and using the input to determine the visual indicia to displayed.

12. One or more computer-readable media having computer-readable instructions thereon which, when executed by one or more processors, cause the one or more processors to implement the method of claim 1.

13. A client device comprising:
computer-readable media;
instructions on the computer-readable media;
one or more processors capable of executing the instructions on the computer-readable media, the instructions causing the one or more processors to:
compute a program score for individual programs that are to be represented in an electronic program guide, the program scores being computed as a function of metadata that describes the programs and user preferences;
compute, from the program scores, a relative score for individual programs, the relative scores providing a measure of how well a particular program relates to the other programs that are to be represented in the electronic program guide; and
display visual indicia of the relative scores of individual programs on the electronic program guide.

14. The client device of claim 13, wherein the instructions cause the one or more processors to display the visual indicia within a cell of the electronic program guide.

15. The client device of claim 13, wherein the instructions cause the one or more processors to display the visual indicia by selecting the visual indicia based upon one or more thresholds associated with the relative scores.

16. The client device of claim 15, wherein the visual indicia comprises one or more symbols.

17. The client device of claim 15, wherein the visual indicia comprises a number.

18. The client device of claim 15, wherein the visual indicia comprises one or more symbols, individual collections of symbols representing a range of relative scores.

19. The client device of claim 15, wherein the visual indicia comprises a color associated with a cell of the electronic program guide that corresponds to the program.

20. A method comprising:
rendering an electronic program guide having individual cells that correspond to individual programs; and
rendering at least one non-textual image that is associated with at least one program within the cell that corresponds to the one program.

21. The method of claim 20, wherein the act of rendering said at least non-textual one image comprises rendering an image of an individual who appears in the program.

22. The method of claim 20, wherein the act of rendering said at least non-textual one image comprises rendering an image of a scene from the program.

23. The method of claim 20, wherein the act of rendering said at least non-textual one image comprises rendering an image of cover art associated with the program.

24. The method of claim 20, wherein the act of rendering said at least non-textual one image comprises rendering a genre-related image associated with a genre of the program.

25. One or more computer-readable media having computer-readable instructions thereon which, when executed by one or more processors, cause the one or more processors to implement the method of claim 20.

26. A client device embodying the computer-readable media of claim 25.

27. An electronic program guide comprising:
multiple cells individual ones of which being associated with individual programs; and
at least one non-textual image visually associated with at least one of the cells, the one image being related to a program that corresponds to the one cell.

28. The electronic program guide of claim 27, wherein said at least one non-textual image comprises an image of an individual who appears in the program.

29. The electronic program guide of claim 27, wherein said at least one non-textual image comprises an image of a scene from the program.

30. The electronic program guide of claim 27, wherein said at least one non-textual image comprises an image of cover art associated with the program.

31. The electronic program guide of claim 27, wherein said at least one non-textual image comprises a genre-related image associated with a genre of the program.

32. The electronic program guide of claim 27, wherein said at least one non-textual image comprises one or more of: an individual who appears in the program, a scene from the program, cover art associated with the program, a genre-related image associated with a genre of the program.

33. A client device embodying the electronic program guide of claim 27.

34. A method comprising:
determining one or more channels that comprise a user's favorite channels; and
rendering an electronic program guide that contains entries for the determined favorite channels.

35. The method of claim 34, wherein the act of rendering comprises displaying only the favorite channels.

36. The method of claim 34, wherein the act of determining the one or more channels comprises receiving user input that indicates which channels are the user's favorites.

37. The method of claim 34, wherein the act of determining comprises determining the favorite channels without requiring the user to input their channel favorites.

38. The method of claim 34, wherein the act of determining comprises determining the favorite channels by analyzing a viewing log associated with a device on which the user views programs.

39. The method of claim 34, wherein the act of determining comprises determining the favorite channels by analyzing a viewing log associated with a device on which the user views programs to ascertain how long a user has viewed programs on a particular channel.

40. The method of claim 34 further comprising setting a threshold that defines the number of favorite channels a user may have, the rendering of the electronic program guide comprising rendering an electronic guide that contains entries does not exceed, in number, the threshold.

41. One or more computer readable media having computer-readable instructions thereon which, when executed by one or more processors, cause the one or more processors to:
determine one or more channels that comprise a user's favorite channels; and
render an electronic program guide that contains entries for the determined favorite channels.

42. The computer readable media of claim 41, wherein the instructions cause the one or more processors to render an electronic program guide that displays only the favorite channels.

43. The computer readable media of claim 41, wherein the instructions cause the one or more processors to determine the one or more channels by receiving user input that indicates which channels are the user's favorites.

44. The computer readable media of claim 41, wherein the instructions cause the one or more processors to determine the favorite channels without requiring the user to input their channel favorites.

45. The computer readable media of claim 41, wherein the instructions cause the one or more processors to determine the favorite channels by analyzing a viewing log associated with a device on which the user views programs.

46. The computer readable media of claim 41, wherein the instructions cause the one or more processors to determine the favorite channels by analyzing a viewing log associated with a device on which the user views programs to ascertain how long a user has viewed programs on a particular channel.

47. A method comprising:
determining one or more channels that comprise a user's favorite channels by evaluating individual programs that are broadcast on the one or more channels; and
rendering an electronic program guide that contains entries for the determined favorite channels.

48. The method of claim 47, wherein the act of evaluating individual programs comprises calculating a score for the individual programs.

49. The method of claim 47, wherein the act of evaluating individual programs comprises calculating a score for the individual programs on a channel as a function of a user's preferences.

50. The method of claim 47, wherein the act of evaluating individual programs comprises calculating a score for all of the individual programs on every channel.

51. The method of claim 47, wherein the act of evaluating individual programs comprises calculating a score for all of the individual programs on every channel as a function of a user's preferences.

52. The method of claim 47, wherein the act of evaluating individual programs comprises:
calculating a score for individual programs appearing on multiple channels; and
for each channel having programs for which a score was calculated, calculating an average program score.

53. The method of claim 52, the act of rendering comprises rendering an electronic program guide that contains only those channels that are determined to be a user's favorites.

54. The method of claim 52 further comprising setting a threshold that defines the number of favorite channels a user may have, the rendering of the electronic program guide comprising rendering an electronic guide that contains entries that do not exceed, in number, the threshold.

55. A client device programmed to implement the method of claim 47.

56. One or more computer readable media having computer-readable instructions thereon which, when executed by one or more processors, cause the one or more processors to:
determine one or more channels that comprise a user's favorite channels by evaluating individual programs that are broadcast on the one or more channels, said evaluating comprising calculating a score for all of the individual programs on every channel as a function of a user's preferences; and
render an electronic program guide that contains only entries for the determined favorite channels.

57. A client device embodying the computer readable media of claim 56.

58. A method comprising:
determining one or more channels that comprise favorite channels of one or more users by evaluating individual programs that are to appear in an electronic program guide in relation to preferences that are specified for the one or more users; and
rendering an electronic program guide that contains only entries for the channels that are determined to be favorite channels.

59. The method of claim 58, wherein the act of evaluating individual programs comprises calculating, for each user, a score for the individual programs.

60. The method of claim 58, wherein the act of evaluating individual programs comprises calculating, for each user, a score for all of the individual programs on every channel.

61. The method of claim 58, wherein the act of evaluating individual programs comprises:
calculating, for each user, a score for individual programs appearing on multiple channels;
for each channel having programs for which a score was calculated and for each user, calculating an average program score; and
rendering an electronic program guide that contains entries for a defined number of channels having the highest average program scores.

62. One or more computer-readable media having computer-readable instructions thereon which, when executed by one or more processors, cause the one or more processors to implement the method of claim 58.

63. A client device embodying the computer-readable media of claim 62.

64. An electronic program guide comprising:
a display having entries associated with one or more channels, each channel entry having multiple cells individual ones of which being associated with individual programs; and
the display comprising only entries for channels that have been determined to be favorite channels.

65. The electronic program guide of claim 64, wherein channels have been determined to be favorite channels through a score-based evaluation of individual programs appearing on each channel.

66. The electronic program guide of claim 64, wherein channels have been determined to be favorite channels through a score-based evaluation of individual programs appearing on each channel, the score-based evaluation first determining, for multiple channels, a score for each channel's programs; computing, for each channel, an average program score; and then determining one or more favorite channels based on the highest average program scores for the channels.

67. The electronic program guide of claim 64, wherein channels have been determined to be favorite channels of one or more users through a score-based evaluation of individual programs appearing on each channel.

68. The electronic program guide of claim 64, wherein channels have been determined to be favorite channels of one or more users through a score-based evaluation of individual programs appearing on each channel, the score-based evaluation comprising a score-based evaluation of the programs in relation to user preferences associated with one or more of the users.

69. A client device embodying the electronic program guide of claim 64.

70. A method comprising:
receiving user input that rates one or more programs that appear in an electronic program guide; and
rendering an electronic program guide that incorporates the user's input.

71. The method of claim 70, wherein the act of rendering comprises providing visual indicia that represents the user's rating.

72. The method of claim 70, wherein the act of rendering comprises excluding, from the electronic program guide, one or more programs that were not favorably rated by the user.

73. One or more computer-readable media having computer-readable instructions thereon which, when executed by one or more processors, cause the one or more processors to implement the method of claim 70.

74. A client device embodying the computer-readable media of claim 73.

75. A method comprising:
receiving user input that defines a scoring range that can be used to assess whether or not to include a particular program in an electronic program guide;
processing scores associated with individual programs to ascertain whether the programs have scores within the user-defined scoring range; and
rendering an electronic program guide that presents visual indicia for programs whose scores are within the user-defined scoring range.

76. The method of claim 75, wherein the act of receiving is performed via a user interface slider that is configured to enable a user to define the scoring range.

77. The method of claim 75, wherein the act of receiving is performed via a user interface slider that is configured to enable a user to define the scoring range, the slider having one or more of an adjustable maximum position and an adjustable minimum position.

78. The method of claim 75, wherein the act of processing the scores comprises processing relative scores associated with the programs, the relative scores providing a measure of how programs relate to other programs that can appear in the electronic program guide.

79. The method of claim 75, wherein the act of rendering comprising rendering an electronic program guide that contains only visual indicia for programs whose scores are within the user-defined scoring range.

80. One or more computer-readable media having computer-readable instructions thereon which, when executed by one or more processors, cause the one or more processors to implement the method of claim 75.

81. A client device embodying the computer-readable media of claim 80.

82. A system comprising:
an electronic program guide application that is configured to render an electronic program guide having multiple entries that provide information on various programs; and
a user input mechanism associated with the electronic program guide application and configured to enable a user to reduce the number of program entries in the electronic program guide.

83. The system of claim 82, wherein the user input mechanism comprises a rating mechanism by which a user can rate programs.

84. The system of claim 82, wherein the user input mechanism comprises a user interface component.

85. The system of claim 82, wherein the user input mechanism comprises a user interface component, the user interface component being configured to enable a user to define a scoring range that can be used to assess whether or not to include a particular program in the electronic program guide.

86. The system of claim 82, wherein the user input mechanism comprises a user interface component, the user interface component being configured to enable a user to define a scoring range that can be used to assess whether or not to include a particular program in the electronic program guide, the electronic program guide application being configured to:
process scores associated with individual programs to ascertain whether the programs have scores within the user-defined scoring range; and
render an electronic program guide that presents visual indicia for programs whose scores are within the user-defined scoring range.

87. The system of claim 82, wherein the user input mechanism comprises a user interface component, the user interface component being configured to enable a user to define a scoring range that can be used to assess whether or not to include a particular program in the electronic program guide, the user interface component comprising a slider.

88. The system of claim 82, wherein the user input mechanism comprises a user interface component, the user interface component being configured to enable a user to define a scoring range that can be used to assess whether or not to include a particular program in the electronic program guide, the user interface component comprising a slider having one or more of an adjustable maximum position and an adjustable minimum position.

89. The system of claim 82, wherein the user input mechanism comprises one or more filters that can be selected by a user for filtering one or more program attributes.

90. The system of claim 82, wherein the user input mechanism comprises one or more filters that can be selected by a user for filtering one or more program attributes, the electronic program guide application being configured to cumulatively apply multiple filters to the programs' attributes.

91. A method comprising:
receiving user input that specifies one or more filters that are to be used to filter programs from an electronic program guide;
using the one or more filters to filter one or more programs from programs that are to be represented in an electronic program guide; and
rendering an electronic program guide that presents visual indicia associated with programs that have not been filtered.

92. The method of claim 91, wherein the filters are configured to filter on program attributes associated with the programs.

93. The method of claim 91, wherein the filters are configured to filter on program attributes associated with the programs, the program attributes being specified by a content description schema.

94. The method of claim 91, wherein the filters are configured to filter on program attributes associated with the programs, the program attributes being specified by an XML content description schema.

95. The method of claim 91, wherein the act of using the filters comprises cumulatively applying the filters to filter the one or more programs.

96. One or more computer-readable media having computer-readable instructions thereon which, when executed by one or more processors, cause the one or more processors to implement the method of claim 91.

97. A client device embodying the computer-readable media of claim 96.

98. A method comprising:
determining one or more programs for recommendation to a user based on program scores associated with individual programs; and
rendering a display that contains one or more recommended programs.

99. The method of claim 98 further comprising prior to determining the one or more programs, computing program scores for the individual programs.

100. The method of claim 98 further comprising prior to determining the one or more programs, computing program scores for the individual programs as a function of user-defined preferences.

101. The method of claim 98, wherein the act of rendering the display comprises rendering a display that contains information associated with the programs and, for at least some of the programs, images associated with the programs.

102. The method of claim 98, wherein the act of rendering the display comprises rendering a display that contains information associated with the programs and, for at least some of the programs, images associated with the programs, the information associated with the programs comprising a score-based rank.

103. The method of claim 98, wherein the act of rendering the display comprises rendering a display that contains information associated with the programs and, for at least some of the programs, images associated with the programs, the information associated with the programs comprising a numerical score.

104. The method of claim 98, wherein the act of rendering the display comprises rendering a display that contains information associated with the programs and, for at least some of the programs, images associated with the programs, the information associated with the programs comprising a score-based rank and a numerical score.

105. One or more computer-readable media having computer-readable instructions thereon which, when executed by one or more processors, cause the one or more processors to implement the method of claim 98.

106. One or more computer-readable media having computer-readable instructions thereon which, when executed by one or more processors, cause the one or more processors to implement the method of claim 98; and a client device embodying the one or more computer-readable media.

107. A method comprising:
determining one or more programs for recommendation to a user based on program scores associated with individual programs;
rendering a display that contains one or more recommended programs;
receiving user input that indicates one or more programs to record for future viewing; and
recording the one or more programs.

108. The method of claim 107 further comprising prior to determining the one or more programs, computing program scores for the individual programs.

109. The method of claim 107 further comprising prior to determining the one or more programs, computing program scores for the individual programs as a function of user-defined preferences.

110. The method of claim 107, wherein the act of rendering the display comprises rendering a display that contains information associated with the programs and, for at least some of the programs, images associated with the programs.

111. The method of claim 107, wherein the act of rendering the display comprises rendering a display that contains information associated with the programs and, for at least some of the programs, images associated with the programs, the information associated with the programs comprising a score-based rank.

112. The method of claim 107, wherein the act of rendering the display comprises rendering a display that contains information associated with the programs and, for at least some of the programs, images associated with the programs, the information associated with the programs comprising a numerical score.

113. The method of claim 107, wherein the act of rendering the display comprises rendering a display that contains information associated with the programs and, for at least some of the programs, images associated with the programs, the information associated with the programs comprising a score-based rank and a numerical score.

114. The method of claim 107 further comprising determining whether any programs selected by the user for recording conflict and, if so, resolving the conflict by ascertaining other recordable instances of one or more of the programs that do not conflict.

115. One or more computer-readable media having computer-readable instructions thereon which, when executed by one or more processors, cause the one or more processors to implement the method of claim 107.

116. One or more computer-readable media having computer-readable instructions thereon which, when executed by one or more processors, cause the one or more processors to implement the method of claim 107; and
a client device embodying the one or more computer-readable media.

117. A method comprising:
determining whether a user has recently viewed a particular program that is to be represented in an electronic program guide; and
rendering an electronic program guide that presents visual indicia that indicates programs that have been recently viewed by the user.

118. The method of claim 117, wherein the visual indicia comprises one or more symbols.

119. The method of claim 117, wherein the visual indicia comprises a number.

120. The method of claim 117, wherein the visual indicia comprises a color associated with a cell of the electronic program guide that corresponds to the program.

121. One or more computer-readable media having computer-readable instructions thereon which, when executed by one or more processors, cause the one or more processors to implement the method of claim 117.

122. One or more computer-readable media having computer-readable instructions thereon which, when executed by one or more processors, cause the one or more processors to implement the method of claim 117; and
a client device embodying the one or more computer-readable media.

123. A method comprising:
determining whether a user has recently viewed a particular program that can be represented in an electronic program guide; and
rendering an electronic program guide that does not contain an entry for at least one program that has been recently viewed by the user.

124. One or more computer-readable media having computer-readable instructions thereon which, when executed by one or more processors, cause the one or more processors to implement the method of claim 123.

125. One or more computer-readable media having computer-readable instructions thereon which, when executed by one or more processors, cause the one or more processors to implement the method of claim 123; and a client device embodying the one or more computer-readable media.

126. A method comprising:
determining one or more programs for recommendation to a user based on program scores associated with individual programs;
determining whether the user has recently viewed a particular program that is to be recommended;
rendering a display that contains one or more recommended programs;
if the user has recently viewed a particular program that is to be recommended, rendering said display to not contain any recommendations for programs that have been recently viewed.

127. The method of claim 126 further comprising prior to determining the one or more programs for recommendation, computing program scores for the individual programs.

128. The method of claim 126 further comprising prior to determining the one or more programs for recommendation, computing program scores for the individual programs as a function of user-defined preferences.

129. The method of claim 126, wherein the act of rendering the display comprises rendering a display that contains information associated with the programs and, for at least some of the programs, images associated with the programs.

130. The method of claim 126, wherein the act of rendering the display comprises rendering a display that contains information associated with the programs and, for at least some of the programs, images associated with the programs, the information associated with the programs comprising a score-based rank.

131. The method of claim 126, wherein the act of rendering the display comprises rendering a display that contains information associated with the programs and, for at least some of the programs, images associated with the programs, the information associated with the programs comprising a numerical score.

132. The method of claim 126, wherein the act of rendering the display comprises rendering a display that contains information associated with the programs and, for at least some of the programs, images associated with the programs, the information associated with the programs comprising a score-based rank and a numerical score.

133. One or more computer-readable media having computer-readable instructions thereon which, when executed by one or more processors, cause the one or more processors to implement the method of claim 126.

134. One or more computer-readable media having computer-readable instructions thereon which, when executed by one or more processors, cause the one or more processors to implement the method of claim 126; and
a client device embodying the one or more computer-readable media.
